(19) United States
(12) Patent Application Publication
(10) Pub. No.: US 2003/0048248 A1
(43) Pub. Date: Mar. 13, 2003

(54) Liquid crystal display device and driving method of the same

(76) Inventors: Tohko Fukumoto, Mobara (JP); Yoshihiro Imajo, Mobara (JP); Nobuhiro Takeda, Mobara (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/214,602

(22) Filed: Aug. 9, 2002

(30) Foreign Application Priority Data
Sep. 13, 2001 (JP) 2001-277799

(51) Int. Cl. G09G 3/36

(52) U.S. Cl. 345/89

(57) ABSTRACT

In the method for driving a liquid crystal display device which has a plurality of picture elements or “pixels” and a drive circuit for outputting to each pixel a gradation voltage as selected from among M (M≧2) gradation voltages, the polarity of a gradation voltage that is outputted from the drive circuit to each pixel is inverted for every N (N≧2)-line group while letting the voltage value of m (1≧m≧M)-th gradation voltage to be outputted from the drive circuit to each pixel be different between when outputting it to the pixels on the first line immediately after the polarity inversion and when outputting it to the pixel on a line which is subsequent to the first line immediately after the polarity inversion and whose polarity is not inverted.

### BACKGROUND OF THE INVENTION

The present invention relates generally to liquid crystal display devices and driving methodology thereof. More particularly, but not exclusively, this invention relates to effective techniques adaptable for use with drive methods for inverting the polarity of gradation voltages as applied to picture elements or “pixels” with a plurality of lines as a unit, such as N-line inversion drive methods.

Liquid crystal display devices of the active matrix type having switching-driven active elements (e.g. thin-film transistors) for each pixel are widely used as display devices for use in personal computers (hereinafter refer to PCs), including notebook PCs.

As one of the active-matrix liquid crystal display devices, a TFT (Thin Film Transistor) type liquid crystal display module is known. This module includes a TFT type liquid crystal display (TFT-LCD) panel, drain drivers disposed along the long side of the liquid crystal display panel, gate drivers or interface unit disposed along the short side of the panel.

Generally, the drain driver internally has a gradation voltage generating circuit, which generates a gradation voltage for applying to the pixels of the LCD panel based on a plurality of gradation reference voltages supplied from the interface unit.

Generally a layer of liquid crystal material is such that when the same voltage (DC voltage) is being applied thereto for an increased length of time period, the inclination of such liquid crystal is fixed, resulting in occurrence of after-image or “ghost” phenomenon. This leads to a decrease in lifetime of the liquid crystal layer.

In order to avoid this problem, the liquid crystal display module is arranged so that a voltage to be applied to the liquid crystal layer is converted into an AC voltage periodically, that is, referring to the common voltage to be applied to a common electrode (shared electrode), the gradation voltage to be applied to a pixel electrode is alternately changed in polarity between positive voltage side and negative voltage side at constant time intervals.

Drive methodology for applying the AC voltage to the liquid crystal layer includes two known methods: a common symmetry method, and a common inversion method.

The common inversion method is a method which alternately inverts the common voltage being applied to a common electrode and the gradation voltage being applied to a pixel electrode between the positive and negative polarities.

The common symmetry method is the one that makes the common voltage as applied to a common electrode stay constant and inverts the gradation voltage being applied to a pixel electrode so that it alternately has the positive and negative polarities with the common voltage to be applied to a common electrode as a reference.

FIG. 30 is a diagram for explanation of the polarity of a gradation voltage (i.e. gradation voltage to be applied to a pixel electrode) which is outputted from a drain driver to a drain signal line in the case of using a dot inversion method as the liquid crystal display module drive method.

With the dot inversion, as shown in FIG. 30, at an odd-numbered line in an odd-numbered frame for example, a gradation voltage (indicated by “•” in FIG. 30) with the negative polarity relative to a common voltage (Vcom) being applied to a common electrode is applied from a drain driver to an odd-numbered drain signal line whereas a gradation voltage (indicated by “∘” in FIG. 30) with the positive polarity relative to a common voltage (Vcom) being applied to a common electrode is applied to an even-numbered drain signal line.

Further, at an even-numbered line in the odd-numbered frame, a positive gradation voltage is applied from the drain driver to an odd-numbered drain signal line; a negative gradation voltage is applied to an even-numbered drain signal line.

In addition, the polarity per each line is inverted for each frame. More specifically, as shown in FIG. 30, at an odd-numbered line of an even-numbered frame, a positive gradation voltage is applied from the drain driver to an odd-numbered drain signal line; a negative gradation voltage is applied to an even-numbered drain signal line.

Further, at an even-numbered line of the even-numbered frame, a negative gradation voltage is applied from the drain driver to an odd-numbered drain signal line; a positive gradation voltage is applied to an even-numbered drain signal line.

By use of this dot inversion method, the voltages that are applied to neighboring drain signal lines are opposite in polarity to each other. Thus it is possible to permit adjacent ones of currents flowing in common electrodes and/or the gate electrodes of thin-film transistors (TFT) to cancel each other, thereby enabling reduction of electrical power consumption.

In addition, the common electrode-flowing current stays less, preventing a voltage drop-down from becoming greater. Thus the common electrode is stabilized in voltage level, enabling minimization of a decrease in on-screen display quality.

However, currently available PCs with a built-in liquid crystal display module which employs the above-described dot inversion method are faced with a problem as follows. Flickers (flicking noises) can occur on the display screen of a liquid crystal display panel in cases where a specified relationship is present between the timing of AC voltage conversion and an image pattern to be visually displayed (e.g. Windows (registered trademark) exit screen or else), which would result in a decrease in display quality.

This problem is solvable by employing as the drive method an N-line (e.g. two-line) inversion method, which inverts the polarity of a gradation voltage being applied from a drain driver to a drain signal line for each N line (e.g. two lines).

However, in the case of employing such N-line (e.g. 2-line) inversion method as the drive method, there has been a problem as follows. A pattern of lateral stripes with a pitch equal to N lines appear on the display screen when displaying a single-colored monotone image on the entire display screen as shown in FIG. 31. This causes the liquid crystal display panel to decrease in display quality significantly.

The present invention has been made in order to avoid the problems faced with the prior art as described above, and an object of this invention is to provide a technique adaptable for use in a liquid crystal display device and a driving method thereof, which technique is for avoiding unwanted creation of a lateral stripe-like “ghost” pattern on a display screen when inverting the polarity of a gradation voltage for each N line (N≧2) to thereby enable the achievement of increased on-screen image display quality.

The above object and new features of the invention will be apparent from the following more particular description of preferred embodiments of the invention, as illustrated in the accompanying drawings.

### SUMMARY OF THE INVENTION

A brief explanation of some representative ones of the inventive concepts as disclosed herein is as follows.

In accordance with one aspect of the present invention, a principal feature lies in that the polarity of a gradation voltage to be outputted from a drive circuit to each pixel is inverted for each N line (N≧2) while at the same time letting the voltage value of an m (1≦m≦M)-th gradation voltage being outputted from the drive circuit to each pixel be different between when outputted to the pixel on a first line immediately after the polarity inversion and when outputted to the pixel on a polarity-noninverted line subsequent to the first line immediately after the polarity inversion.

An example is that the absolute value of a difference between the m-th gradation voltage being output from the drive circuit to each pixel and a common voltage is made greater when outputting a gradation voltage from the drive circuit to the pixel on the first line immediately after the polarity inversion than when outputting a gradation voltage from the drive circuit to the pixel on the polarity-noninverted line.

In accordance with another aspect of this invention, the absolute value of a difference between the gradation voltage to be outputted from the drive circuit to the pixel on the first line immediately after the polarity inversion and the gradation voltage to be outputted from the drive circuit to the pixel on the polarity-noninverted line is made different for each gradation level.

In accordance with still another aspect of the invention, the absolute value of a difference between the gradation voltage to be outputted from the drive circuit to the pixel on the first line immediately after the polarity inversion and the gradation voltage to be outputted from the drive circuit to the pixel on the polarity-noninverted line is specifically arranged to become greater with an increase in the absolute value of a difference between the gradation voltage and the common voltage.

In accordance with yet another aspect of the invention, the absolute value of a difference between the m-th gradation voltage to be outputted from the drive circuit to the pixel on the first line immediately after the polarity inversion and the m-th gradation voltage to be outputted from the drive circuit to the pixel on the polarity-noninverted line is arranged to increase with an increase in distance between a presently scanned line and the drive circuit.

In accordance with a further aspect of the invention, in order to make the voltage value of m (1≦m≦M)-th gradation voltage to be outputted from the drive circuit to each pixel different between when outputted to the pixel on the first line immediately after the polarity inversion and when outputted to the pixel on the polarity-noninverted line subsequent to the first line immediately after the polarity inversion, let the voltage value of a k (1≦k≦K)-th gradation reference voltage to be supplied from a power supply circuit to the drive circuit differ between when outputting a gradation voltage from the drive circuit to the pixel on the first line immediately after the polarity inversion and when outputting a gradation voltage from the drive circuit to the pixel on the polarity-noninverted line subsequent to the first line immediately after the polarity inversion.

In accordance with another aspect of the invention, a horizontal scanning time period of the line is arranged so that this period is different between when outputting a gradation voltage from the drive circuit to the pixel on the first line immediately after the polarity inversion and when outputting a gradation voltage from the drive circuit to the pixel on the polarity-noninverted line.

With use of the above-noted means, it is possible to equalize a voltage to be written into the pixel on the line immediately after the polarity inversion to a voltage to be written into the pixel on another line that is subsequent to the line immediately after the polarity inversion, which in turn makes it possible to prevent a creation of lateral stripes on the display screen of a liquid crystal display device, thus enabling achievement of the improved display quality of such display screen. Note that the language “subsequent to” as used herein is to be understood to mean “next to” or “following” or “the following”.

### BRIEF DESCRIPTION OF THE DRAWINGS

FIG. 1 is a block diagram schematically showing an arrangement of a liquid crystal display module of the TFT type, to which the present invention is applied.

FIG. 2 is a diagram showing one exemplary equivalent circuit of a liquid crystal display panel shown in FIG. 1.

FIG. 3 is a diagram showing another exemplary equivalent circuit of the liquid crystal display panel shown in FIG. 1.

FIG. 4 is a block diagram schematically showing an exemplary configuration of a drain driver shown in FIG. 1.

FIG. 5 is a circuit diagram showing a schematic configuration of a gradation reference voltage generation circuit shown in FIG. 1.

FIG. 6 is a diagram for explanation of the polarity of a gradation voltage to be outputted from a drain driver to a drain signal line (D) in case a 2-line inversion method is used as a liquid crystal display module drive method.

FIG. 7 is a diagram for explanation of the reason why lateral stripes take place on the display screen when the 2-line inversion method is used as the liquid crystal display module drive method.

FIG. 8 is a diagram for explanation of a summary of a drive method in accordance with Embodiment 1 of the invention.

FIG. 9 is a circuit diagram schematically showing a configuration of a gradation reference voltage generator circuit of the liquid crystal display module of Embodiment 1 of the invention.

FIG. 10 is a circuit diagram showing a circuit configuration of an example of a correction circuit 1 or correction circuit 5 shown in FIG. 9.

FIG. 11 is a diagram showing voltage levels of output voltages of the corrector circuit shown in FIG. 10.

FIGS. 12A to 12E are waveform diagrams showing examples of a correction voltage (ΔVm) generated at a correction voltage generator unit shown in FIG. 10.

FIG. 13 is a diagram showing waveforms of the correction voltages (ΔVm) shown in FIGS. 12B and 12C when being inputted to an inversion amplifier circuit through a switch circuit.

FIG. 14 is a graph showing an example of the correction voltage (ΔVm) that is given to each gradation voltage with the positive polarity in the embodiment of the invention.

FIG. 15 is a circuit diagram schematically showing a configuration of a gradation reference voltage generation circuit of a liquid crystal display module in accordance with Embodiment 2 of the invention.

FIG. 16 is a circuit diagram schematically showing a configuration of a gradation reference voltage generator circuit of a liquid crystal display module in accordance with Embodiment 3 of the invention.

FIG. 17 is a circuit diagram showing a circuit configuration for a generation of an AC-converted signal (M) and line discrimination signal (LB) in the liquid crystal display module of each embodiment of the invention.

FIG. 18 is a diagram showing a timing chart in the case of a 8 (n=3) line inversion method in the circuit shown in FIG. 17.

FIG. 19 is a diagram for explanation of the case for correction of a gradation voltage being outputted from a drain driver to a pixel(s) on n-th line in the liquid crystal display module of the Embodiment 1 of the invention.

FIG. 20 is a diagram for explanation of the case for correction of a gradation voltage to be outputted from the drain driver to a pixel(s) on (n+1)-th line in the liquid crystal display module of the Embodiment 1 of the invention.

FIG. 21 is a diagram for explanation of the case for correction of a gradation voltage to be outputted from the drain driver to the pixels on the n-th line and (n+1)-th line in the liquid crystal display module of the Embodiment 1 of the invention.

FIG. 22 is a diagram showing a liquid crystal display panel with drain drivers mounted along its both long sides.

FIGS. 23A and 23B are diagrams each showing the waveform of a correction voltage (ΔVm) in the case of the liquid crystal display panel shown in FIG. 22.

FIG. 24 is a diagram for explanation of a summary of a drive method in accordance with Embodiment 4 of the invention.

FIG. 25 is a diagram for explanation of an exemplary method for lengthening one horizontal scan time period of the n-th line immediately after polarity conversion in the liquid crystal display module of the Embodiment 4 of the invention.

FIG. 26 is a diagram for explanation of another exemplary method for lengthening one horizontal scan time period of the n-th line immediately after the polarity conversion in the liquid crystal display module of the Embodiment 4 of the invention.

FIG. 27 is a diagram for explanation of a further exemplary method for lengthening one horizontal scan time period of the n-th line immediately after the polarity conversion in the liquid crystal display module of the Embodiment 4 of the invention.

FIGS. 28A to 28C are diagrams each of which is for explanation of the case of a combined use of the method for lengthening one horizontal scan time period of n-th line immediately after the polarity conversion and a method for correcting a gradation voltage to be outputted from a drain driver in the liquid crystal display module of Embodiment 4 of the invention.

FIG. 29 is a circuit diagram showing a configuration of a circuit which adjusts a clock (CL1) generation timing in the liquid crystal display module of the Embodiment 4 of the invention.

FIG. 30 is a diagram for explanation of the polarity of a liquid crystal drive voltage to be outputted from a drain driver to a drain signal line (D) in the case of using a dot-inversion method as the liquid crystal display module drive method.

FIG. 31 is a diagram showing a pictorial diagram of a pattern of lateral stripes occurring on the liquid crystal display panel in case N-line (e.g. 2-line) inversion method is used as the drive method.

### DESCRIPTION OF THE PREFERRED EMBODIMENTS

Preferred embodiments of the present invention will be explained in detail with reference to the accompanying drawings below.

It should be noted that in all of the drawings for explanation of the embodiments of the invention, parts having the same function are denoted by the same reference characters, with any repetitive explanation thereof eliminated herein.

[Embodiment 1]

<Basic Arrangement of TFT Type Liquid Crystal Display Module Embodying the Invention>

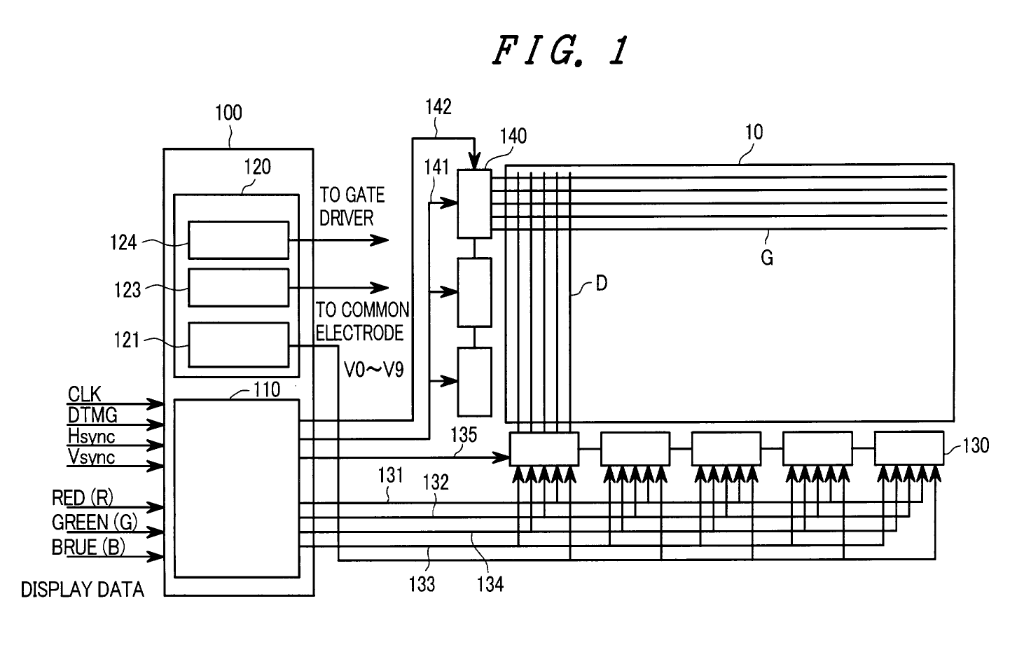

FIG. 1 is a block diagram schematically showing an overall configuration of a liquid crystal display module of the TFT type embodying the invention.

The liquid crystal display module (LCM) shown in FIG. 1 includes a TFT-type liquid crystal display (TFT-LCD) panel 10, with drain drivers 130 disposed along its long sides and with gate drivers 140 laid out along short sides of the liquid crystal display panel 10.

These drain drivers 130 and gate drivers 140 are directly mounted on one glass substrates (e.g. TFT substrate) of the liquid crystal display panel 10 at peripheral portions thereof.

An interface unit 100 is mounted on an interface substrate, which in turn is mounted on a rear side of the liquid crystal display panel 10.

<Arrangement of Liquid Crystal Display Panel 10 Shown in FIG. 1>

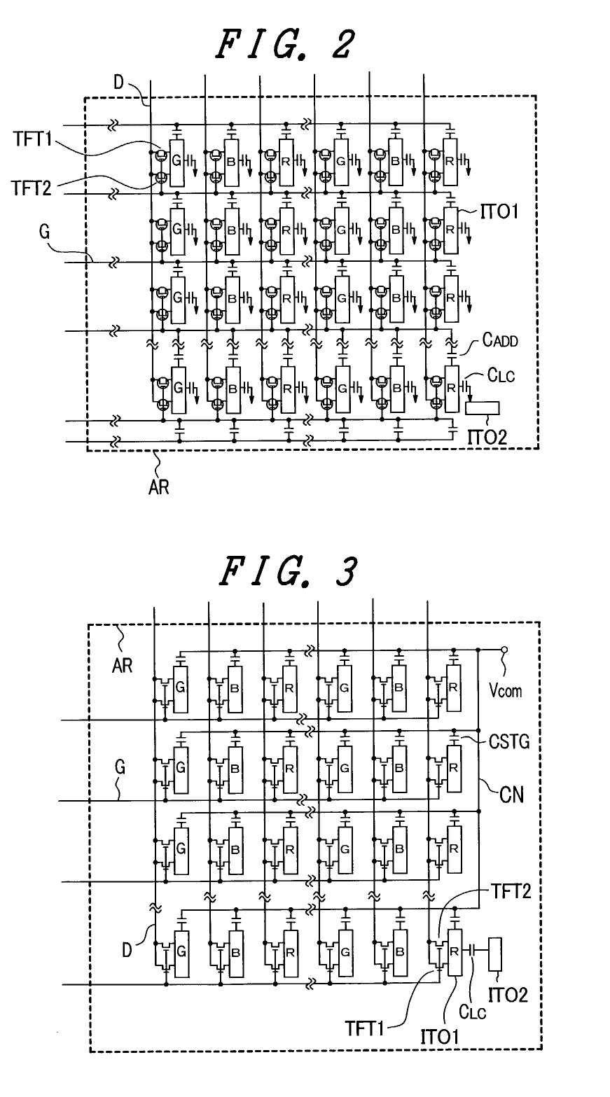

FIG. 2 is a diagram showing an exemplary equivalent circuit of the liquid crystal display panel 10 shown in FIG. 1. As shown in FIG. 2, the liquid crystal display panel 10 has a plurality of “pixels,” which are formed into a matrix array.

Each pixel is disposed within a crossing or “intersection” region of two neighboring signal lines (drain signal lines (D) or gate signal lines (G)) and two adjacent signal lines (gate signal lines (G) or drain signal lines (D)).

Each pixel has thin-film transistors (TFT1, TFT2) having source electrodes connected to a pixel electrode (ITO1).

As a layer of liquid crystal material is provided between the pixel electrode (ITO1) and a common electrode (ITO2), a liquid crystal capacitance (CLC) is equivalently connected between the pixel electrode (ITO1) and the common electrode (ITO2).

Further, an additional capacitance (CADD) is connected between the source electrodes of thin-film transistors (TFT1, TFT2) and a gate signal line (G) at its pre-stage.

FIG. 3 is a diagram showing an equivalent circuit of another example of the liquid crystal display panel 10 shown in FIG. 1.

Although in the example shown in FIG. 2 the additional capacitance (CADD) is formed between the pre-stage gate signal line (G) and the source electrodes, the equivalent circuit of the example shown in FIG. 3 is different therefrom in that a storage capacitance (CSTG) is formed between a common signal line (CN) to which a common voltage (Vcom) is applied and the source electrodes. This invention is applicable to the both of them.

Note that FIGS. 2 and 3 show equivalent circuits of a liquid crystal display panel of the type using longitudinal electric field types, wherein “AR” is used to designate a display area in FIGS. 2 and 3. In addition, although FIGS. 2 and 3 are circuit diagrams, these are depicted in a way corresponding to actual geometrical layout.

In the liquid crystal display panels 10 shown in FIGS. 2 and 3, the thin-film transistors (TFT1, TFT2) of each pixels as disposed in a column direction have drain electrodes which are connected to drain signal lines (D) respectively. Each drain signal line (D) is connected to a drain driver 130 for applying a gradation voltage to the liquid crystal material of each pixel in the column direction.

Additionally, gate electrodes of the thin-film transistors (TFT1, TFT2) in each pixel disposed in a row direction are connected to gate signal lines (G) respectively, wherein each gate signal line (G) is connected to a gate driver 140 which supplies a scan drive voltage (positive bias voltage or negative bias voltage) to the gate electrodes of the thin-film transistors (TFT1, TFT2) of each pixel in the row direction within a single horizontal scan time period.

<Arrangement and Operation of Interface Unit 100 Shown in FIG. 1>

The interface unit 100 shown in FIG. 1 is generally constituted from a display control device 110 and a power supply circuit 120.

The display control device 110 is formed of a single semiconductor integrated circuit (such as an LSI chip), which controls and drives the drain drivers 130 and gate drivers 140 based on signals sent from the computer main body side, which signals include display data (R.G.B) and respective display control signals such as clock signals (CLK), a display timing signal (DTMG), a horizontal synchronize signal (Hsync), and a vertical synchronize signal (Vsync).

Upon input of the display timing signal, the display control device 110 determines this as a display start-up position and then outputs a start pulse (display data accept start signal) to a first drain driver 130 through a signal line 135 and further outputs a simple single array of display data thus received to the drain drivers 130 via a display data bus line 133.

In this event, the display control device 110 outputs via a signal line 131 a display data latch-use clock (CL2) (simply referred to as “clock (CL2)” hereinafter) which is a display control signal used to latch display data in a data latch circuit of each drain driver 130.

The display data from the main-body computer side may be transferred in a way such that 6 bits of data make up a single pixel unit—that is, respective data of red (R), green (G) and blue (B) are combined together into a single set—and are sent forth on a per-pixel basis for every unit time, by way of example.

Additionally, a latch operation of the data latch circuit in the first drain driver 130 is controlled by the start pulse inputted to the first drain driver 130.

Upon termination of the latch operation of the data latch circuit at this first drain driver 130, the start pulse is inputted from the first drain driver 130 to a second drain driver 130, whereby a latch operation of the data latch circuit in the second drain driver 130 is controlled.

Thereafter, a latch operation of the data latch circuit at each drain driver 130 is controlled in a similar way to that stated above, thereby preventing erroneous display data from being written into the data latch circuits.

Upon termination of inputting of the display timing signal or, alternatively, when a prespecified length of time elapses since the display timing signal was inputted, the display control device 110 determines that the display data corresponding to one horizontal period has expired and then outputs an output timing control clock (CL1) (referred to simply as “clock (CL1)” hereinafter) to each drain driver 130 via a signal line 132, wherein the clock (CL1) is a display control signal which is used to output the display data that has been stored at the data latch circuit in each drain driver 130 toward the drain signal line (D) of the liquid crystal display panel 10.

Additionally, upon input of a first display timing signal after the input of a vertical synchronize signal, the display control device 110 judges this as a first display line and then outputs a frame start instruction signal (FLM) to the gate driver(s) 140 via a signal line 142.

Furthermore, the display control device 110 outputs, based on a horizontal synchronize signal, a clock signal (CL3) which is a shift clock of one horizontal scan time period to the gate driver(s) 140 via a signal line 141 in such a way as to sequentially apply the positive bias voltage to the respective gate signal lines (G) of the liquid crystal display panel 10, for each horizontal scan time.

Whereby, a plurality of thin-film transistors (TFT) as connected to each gate signal line (G) of the liquid crystal display panel 10 are driven to turn on within a single horizontal scan time.

With the operation above, an image is visually displayed on the liquid crystal display panel 10.

<Arrangement of Power Supply Circuit 120 Shown in FIG. 1>

The power supply circuit 120 shown in FIG. 1 is made up of a gradation reference voltage generating circuit 121, a common electrode (opposite or “counter” electrode) voltage generation circuit 123, and a gate electrode voltage generation circuit 124.

The gradation reference voltage generator circuit 121 is configured from a serial-resistor voltage divider circuit, which outputs gradation reference voltages (V0 to V9) with ten values.

These gradation reference voltages (V0 to V9) are supplied to each drain driver 130.

Additionally an AC-converted signal (AC-converted timing signal denoted by “M”) from the display control device 110 is also supplied to each drain driver 130 via a signal line 134.

A common electrode voltage generator circuit 123 generates a drive voltage to be applied to the common electrode (ITO2); the gate electrode voltage generator circuit 124 generates a drive voltage (positive bias voltage or negative bias voltage) to be applied to the gate electrodes of thin-film transistors (TFT).

<Arrangement of Drain Driver 130 Shown in FIG. 1>

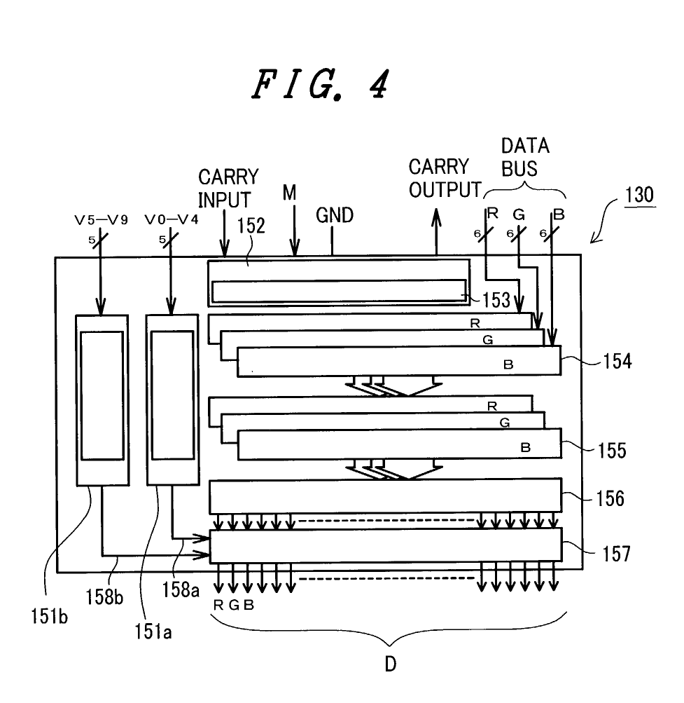

FIG. 4 is a diagram showing, in schematic block diagram, an exemplary configuration of one of the drain drivers 130 shown in FIG. 1. Note that the drain driver 130 is formed of a single semiconductor integrated circuit (LSI).

In FIG. 4, a positive-polarity gradation voltage generation circuit 151a generates a positive gradation voltage with sixty four (64) gradation or gradation voltage, based on five-value gradation reference voltages (V0 to V4) which are supplied from the gradation reference voltage generator circuit 121, and then outputs it to an output circuit 157 via a voltage bass line 158a.

A negative-polarity gradation voltage generation circuit 151b generates a negative gradation voltage with 64 tone levels based on five-value gradation reference voltages (V5 to V9) as supplied from the gradation reference voltage generator circuit 121 and then outputs it to the output circuit 157 via a voltage bass line 158b.

A shift register circuit 153 within the control circuit 152 of a drain driver 130 generates, based on the clock (CL2) inputted from the display control device 110, a data accept-use signal of an input register circuit 154 and then outputs it to the input register circuit 154.

The input register circuit 154 latches, based on the data accept signal outputted from the shift register circuit 153, a specific number of display data for each color of—6 bits—in a way synchronous with the clock (CL2) that is inputted from the display control device 110.

A storage register circuit 155 latches the display data within the input register circuit 154 in response to the clock (CL1) inputted from the display control device 110.

The display data as taken into this storage register circuit 155 is then inputted to the output circuit 157 via a level shift circuit 156.

The output circuit 157 selects, based on either the 64-level positive gradation voltage or the 64-level negative gradation voltage, a single gradation voltage corresponding to the display data (i.e. gradation voltage with one of 64 tone levels) and then outputs it to each drain signal line (D).

<Arrangement of Gradation Reference Voltage Generator Circuit 121 Shown in FIG. 1>

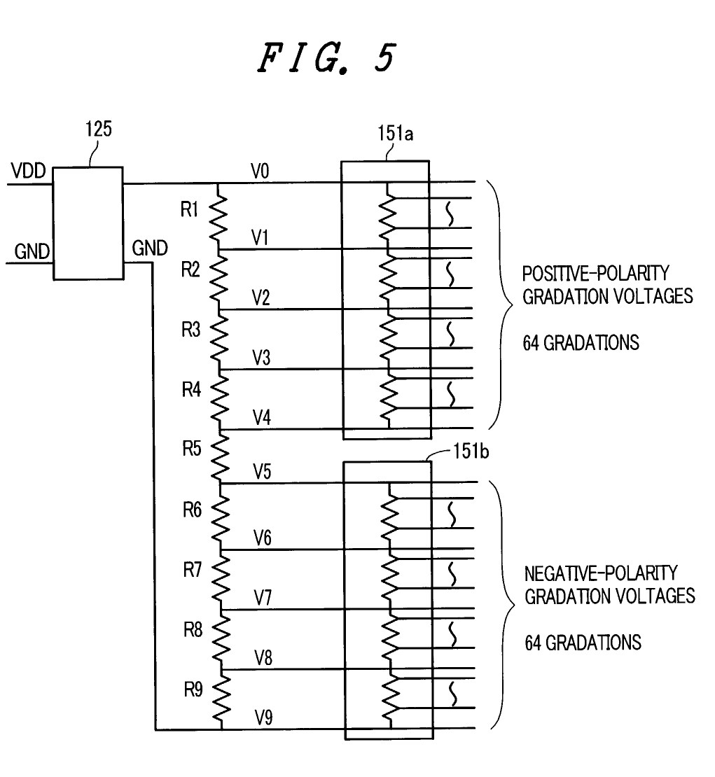

FIG. 5 is a circuit diagram schematically showing a configuration of the gradation reference voltage generator circuit 121 shown in FIG. 1.

As shown in FIG. 5, the gradation reference voltage generator circuit 121 is formed of a resistive voltage divider circuit which consists essentially of resistors R1 to R9. This resistive voltage divider circuit potentially divides a voltage potentially midway between a voltage V0 outputted from a DC/DC converter 125 and ground potential (GND) to thereby generate gradation reference voltages of V0 to V9.

The five-value gradation reference voltages (V0 to V4) which are outputted from the resistive voltage divider circuit are inputted to the positive gradation reference voltage generator circuit 151a within a drain driver 130. As stated previously, the positive gradation voltage generator circuit 151a potentially divides these positive five-value gradation reference voltages (V0 to V4) to thereby generate positive gradation voltages with 64 tone levels.

Similarly, the other five-value gradation reference voltages (V5 to V9) outputted from the resistive voltage divider circuit are inputted to the negative gradation voltage generator circuit 151b within a drain driver 130. As stated supra, this negative gradation voltage generator circuit 151b potentially divides these negative five-value gradation reference voltages (V5 to V9) to generate negative gradation voltages with 64 tone levels.

### SUMMARY OF THE INVENTION

With the liquid crystal display module in accordance with this embodiment, it employs a two-line inversion method as the driving method thereof.

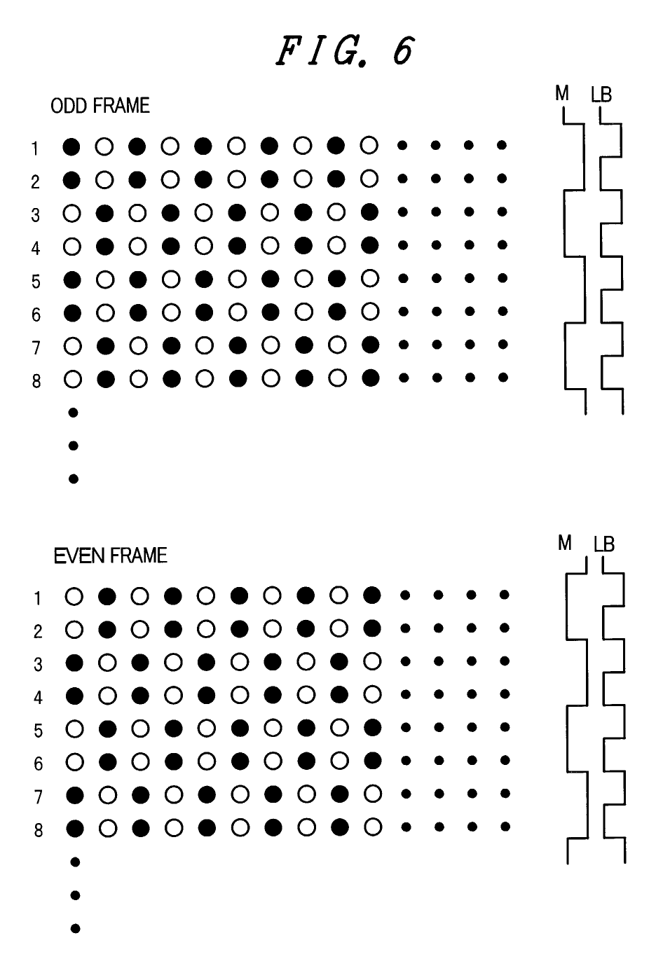

FIG. 6 is a diagram for explanation of the polarity of a gradation voltage which is outputted from a drain driver 130 to a drain signal line (D) (i.e. gradation voltage to be applied to the pixel electrode) in the case of using the 2-line inversion method as the liquid crystal display module driving method. Note that in FIG. 6, a positive gradation voltage is indicated by “∘” whereas a negative gradation voltage is by “•.”

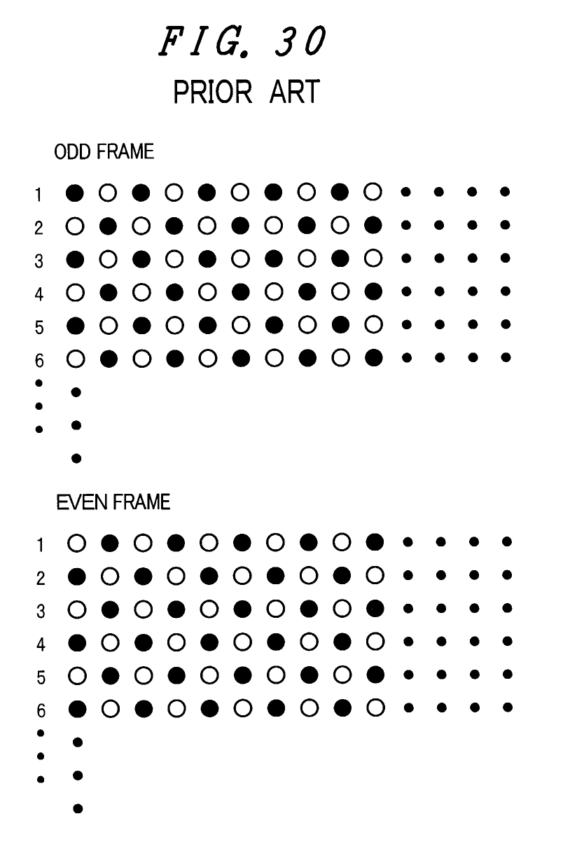

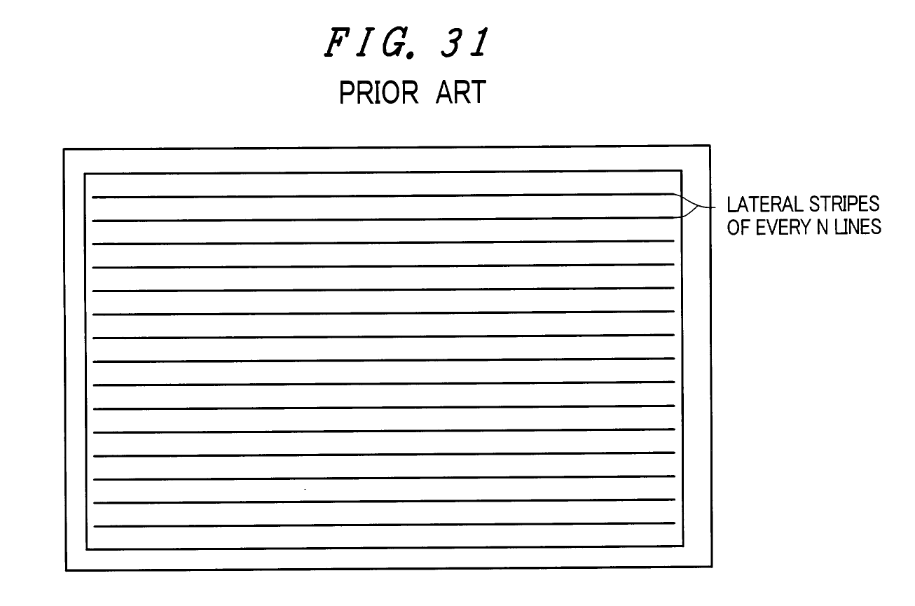

The 2-line inversion method is merely different from the above-noted dot inversion method shown in FIG. 30 in that the polarity of a gradation voltage being outputted from a drain driver 130 to a drain signal line (D) is inverted for every two-line group. Thus, any detailed explanation thereof will be omitted.

For instance, in case a picture image with the same gradation is displayed on the liquid crystal display panel 10, with the 2-line inversion method, the drain driver 130 outputs a polarity-inverted gradation voltage to the drain signal line (D) for every two-line group.

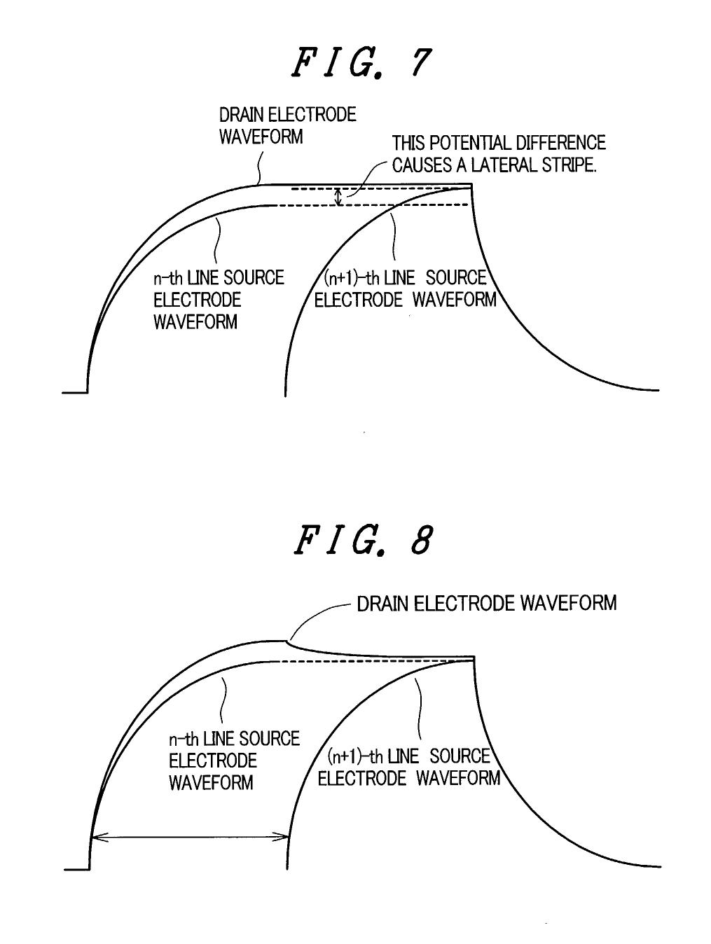

An explanation will be given of the reason why the above-described lateral stripes occur in the case of using the 2-line inversion method, with reference to FIG. 7 below.

Now, consider the case where the polarity of a gradation voltage that the drain driver 130 outputs to a drain signal line (D) is changed from the negative to the positive polarity.

While in this case the gradation voltage on the drain signal line (D) is negative in polarity prior to inversion of the polarity of such gradation voltage and becomes positive after completion of the polarity inversion, a drain signal line (D) may be regarded as one type of distribution constant line path so that it is impossible to immediately change from the negative gradation voltage to the positive gradation voltage, resulting in the gradation voltage changing from the negative to the positive polarity with the presence of a certain delay time as indicated by a drain electrode waveform in FIG. 7.

In contrast, at a line which is subsequent to the line immediately after the polarity inversion, the polarity of a gradation voltage being outputted from a drain driver 130 to a drain signal line (D) is kept unchanged so that a voltage on the drain signal line (D) becomes a predefined gradation voltage.

Due to this, as shown in FIG. 7, a source electrode waveform at the (n+1)th line which is subsequent to the n-th line immediately after the polarity inversion rises up more rapidly than the source electrode waveform of the n-th line immediately after the polarity inversion.

The same goes with another case where the polarity of a gradation voltage to be outputted by the drain driver 130 to the drain signal line D is changed from the positive to the negative polarity.

For the reason described above, a voltage to be written into a pixel on the line immediately after the polarity inversion as indicated in the source electrode waveform of the n-th line in FIG. 7 and a voltage being written into the pixel on the line subsequent to the line immediately after the polarity inversion as shown in the (n+1)th line's source electrode waveform in FIG. 7 become different from each other irrespective of the fact that an attempt is made to display the same gradation, resulting in the generation of the on-screen “ghost” pattern with lateral stripes stated supra.

This becomes more visible to human eyes in the case of higher pixel resolutions of the liquid crystal display panel 10, such as 1280×1024 pixels of SXGA display mode and 1600×1200 pixels in UXGA display mode, for example.

As apparent from the foregoing, lateral stripes of the type stated above generate due to the presence of a difference between the voltage as written into the pixel(s) on the line immediately after the polarity inversion and the voltage to be outputted written into the pixel(s) on the line subsequent to the line immediately after the polarity inversion.

To avoid this, the present invention employs a specific technique for correcting at the line immediately after the polarity inversion the voltage of a gradation voltage to be outputted from the drain driver 130 to drain signal line (D) as shown in FIG. 8 to thereby equalize the voltage being written into the pixel(s) on the line immediately after the polarity inversion to the voltage being written into the pixel(s) on the line subsequent to the line immediately after the polarity inversion.

In brief, even in the case of displaying the same gradation, in the event of a change from the negative to the positive polarity, as shown by a drain electrode waveform in FIG. 8, at the line immediately after the polarity inversion, correction is performed in such a way that the voltage of a positive gradation voltage being outputted from the drain driver 130 to a drain signal line (D) becomes at a higher potential level from the common voltage (Vcom) while at the line subsequent to the line immediately after the polarity inversion outputting a positive gradation voltage of a predetermined tone level from the drain driver 130 to a drain signal line (D); alternatively, when a change is from the positive to the negative polarity, correction is done in such a way that at the line immediately after the polarity inversion the voltage of a negative gradation voltage to be outputted from the drain driver 130 to a drain signal line (D) becomes a lower potential from the common voltage (Vcom) while at the line subsequent to the line immediately after the polarity inversion outputting a negative gradation voltage of a predefined tone level from the drain driver 130 to a drain signal line (D).

With such an arrangement, as shown by a source electrode waveform of the n-th line in FIG. 8 and shown by source electrode waveform of the (n+1)th line of FIG. 8, it is possible in the present invention to make the voltage being written into the pixel(s) on the line immediately after the polarity inversion equal to the voltage as written into the pixel(s) on the line subsequent to the line immediately after the polarity inversion.

This embodiment is the one that corrects at this line immediately after the polarity inversion the gradation reference voltage to be supplied to the drain driver 130 in order to correct or “amend” the voltage of a gradation voltage to be outputted from the drain driver 130 to a drain signal line (D).

<Characteristic Arrangement of Liquid Crystal Display Module of the Embodiment>

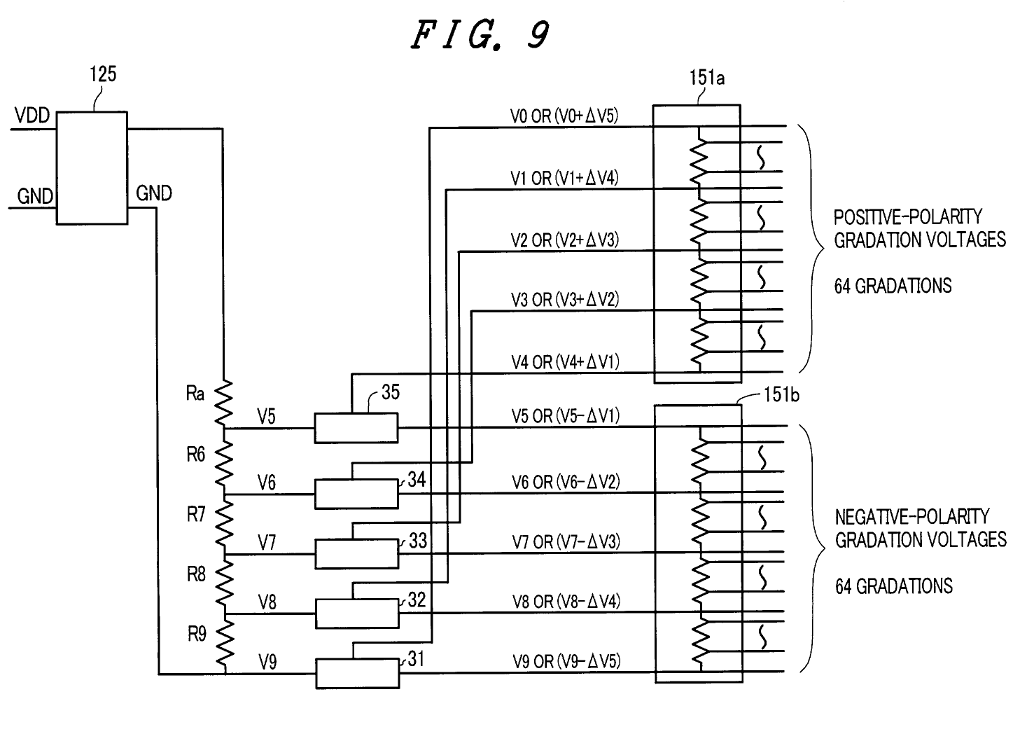

FIG. 9 is a circuit diagram showing a schematical configuration of the gradation reference voltage generator circuit 121 of the liquid crystal display module of this embodiment.

As shown in FIG. 9, with this embodiment, a resistive voltage divider circuit consisting essentially of a resistor Ra and resistors R6 to R9 is provided to potentially divide a voltage between the voltage V0 outputted from the DC/DC converter 125 and the ground potential (GND) to thereby generate gradation reference voltages of V5 to V9.

These gradation reference voltages are inputted to a correction circuit 1 (31) to a correction circuit 5 (35) in such a way as to supply corrected gradation reference voltages from the corrector circuits to drain drivers 130 when scanning the line immediately after the polarity inversion and supply in the other case predefined gradation reference voltages from the corrector circuits to a drain drivers 130.

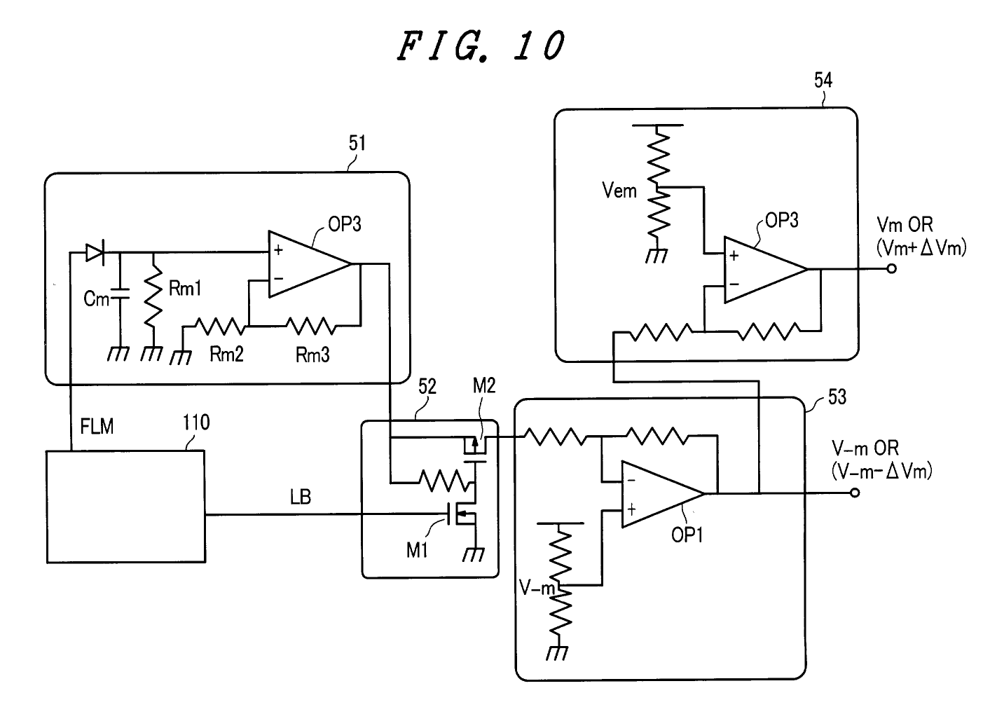

FIG. 10 is a circuit diagram showing an exemplary circuit configuration of one of the corrector circuit 1 (31) to corrector circuit 5 (35) shown in FIG. 9.

The corrector circuit shown in FIG. 10 is formed of a correction voltage generation unit 51, a switch circuit 52, an inversion type amplifier circuit 1 (53), and an inverting amplifier circuit 2 (54).

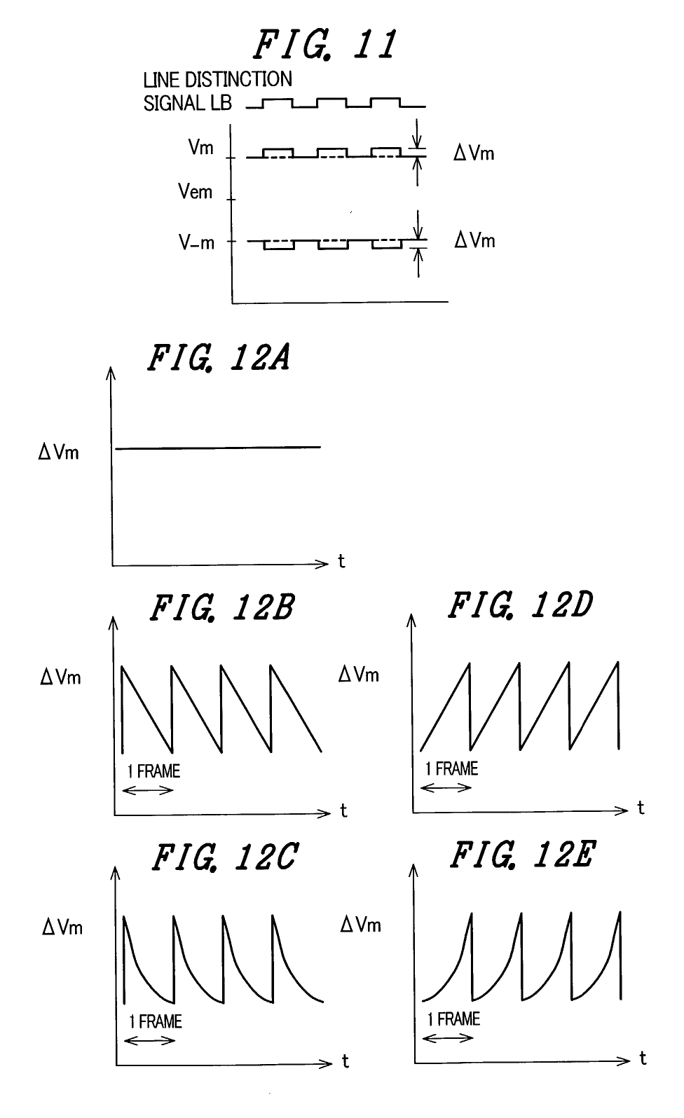

FIG. 11 is a diagram showing voltage levels of output voltages of the corrector circuit shown in FIG. 10. An explanation will be given of an operation of the corrector circuit shown in FIG. 10 with reference to FIG. 11 below.

The correction voltage generator unit 51 is the one that generates a correction voltage. An arrangement and operation of this correction voltage generator unit 51 will be described later.

The switch circuit 52 is made up of an NMOS transistor (M1) and a PMOS transistor (M2), wherein the MOS transistors (M1, M2) turn off when a correction line discrimination signal (LB) is at Low or “L” level.

In this case, an operational amplifier (OP1) of the inverting amplifier circuit 1 (53) constitutes a voltage follower circuit, wherein an output of the op-amp (OP1) becomes a voltage of V₋ₘ which is to be applied to a non-inverting terminal as shown in FIG. 11.

In addition, since this output is inputted to the inverting amplifier circuit 2 (54), an output of the inverting amplifier circuit 2 (54) is such that the voltage of V₋ₘ becomes an inverted and amplified voltage Vₘ with a voltage of Vem that is applied to the non-inverting terminal of an op-amp (OP2) of the inverting amplifier circuit 2 (54) being as a reference, as shown in FIG. 11.

When the correction line discrimination signal (LB) is at High (refer to just H level hereinafter), the MOS transistors (M1, M2) turn on causing a correction voltage (ΔVm) as generated at the correction voltage generator unit 51 to be inputted to the inverting amplifier circuit 1 (53).

At this time, as shown in FIG. 11, an output of the inverting amplifier circuit 1 (53) is such that the voltage of Vₘ becomes an inverted and amplified voltage (V₋ₘ−ΔVm) with the voltage of V₋ₘ applied to the non-inverting terminal of the op-amp (OP1) of the inverting amplifier circuit 1 (53) being as a reference.

Additionally, as shown in FIG. 11, an output of the inverting amplifier circuit 2 (54) at this time is such that the voltage of (V₋ₘ−ΔVm) becomes an inverted and amplified voltage (Vₘ+ΔVm) with the voltage of Vem applied to the non-inverting terminal of the op-amp (OP2) of the inverting amplifier circuit 2 (54) being as a reference.

This voltage is inputted to the positive gradation voltage generator circuit 151a and the negative gradation voltage generator circuit 151b of the drain driver 130. Thus, when scanning the line immediately after the polarity inversion, a corrected gradation voltage is outputted from the drain driver 130 to drain signal line (D); in the other times, a predetermined gradation reference voltage is outputted from the drain driver 130 to drain signal line (D), thereby enabling prevention of the generation of a lateral stripe pattern of the type stated supra.

Next, an explanation is given of the correction voltage generator unit 51.

The above-stated lateral stripes become greater with an increase in distance from the drain drivers 130. This can be the because a time taken for a drain signal line (D) to change to a predefined gradation voltage immediately after the polarity inversion becomes larger with an increase in distance from the drain drivers 130.

More specifically, while the voltage waveform of drain signal line (D) can experience waveform-rounding corruption, this waveform corruption increases with an increase in distance from the drain drivers 130, which would result in a difference between the voltage as written into the pixel(s) on the line immediately after the polarity inversion and the voltage being written into the pixel(s) on the line subsequent to the line immediately after the polarity inversion becoming greater with respect to a scan line which is far from the drain drivers 130.

Due to this, the correction voltage (ΔVm) to be generated by the correction voltage generator unit 51 is not any potentially constant voltage but is required to be variable in accordance with the distance between a scan line and drain driver 130.

FIGS. 12A to 12E are waveform diagrams showing exemplary voltage waveforms of the correction voltage (ΔVm) as generated by this correction voltage generator unit 51. It is noted that in FIGS. 12A to 12E, the case where the correction voltage (ΔVm) is constant is shown in FIG. 12A for comparison purposes.

FIGS. 12B and 12C show voltage waveforms of the correction voltage (ΔVm) in case the drain drivers 130 are mounted on the underside of the liquid crystal display panel 10; FIGS. 12D to 12E show voltage waveforms of the correction voltage (ΔVm) in case the drain drivers 130 are mounted on the upper side of the liquid crystal display panel 10.

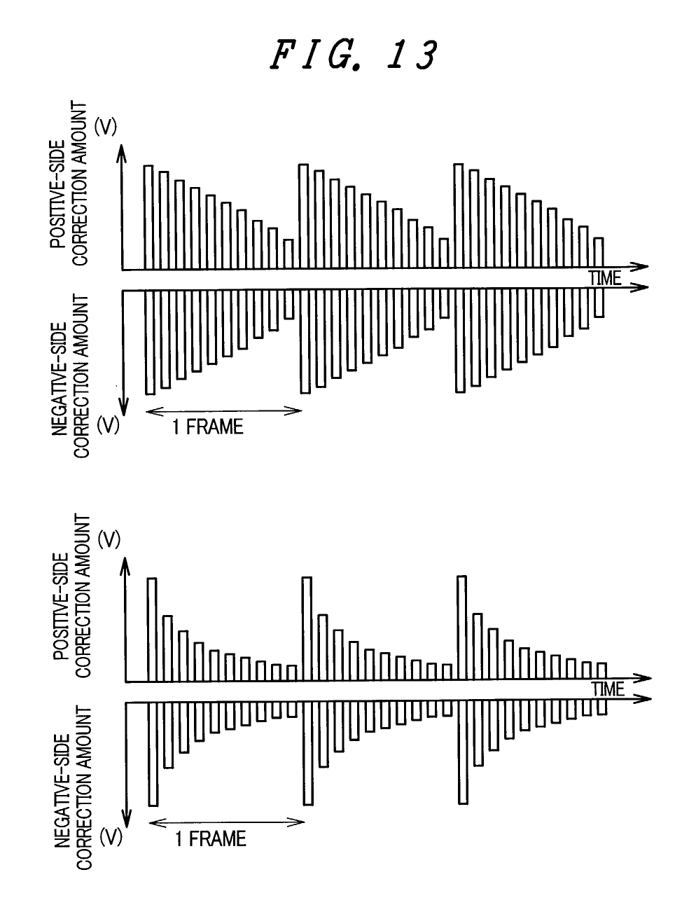

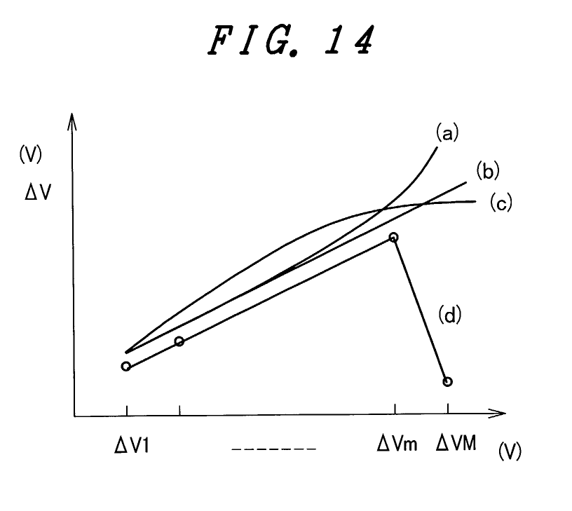

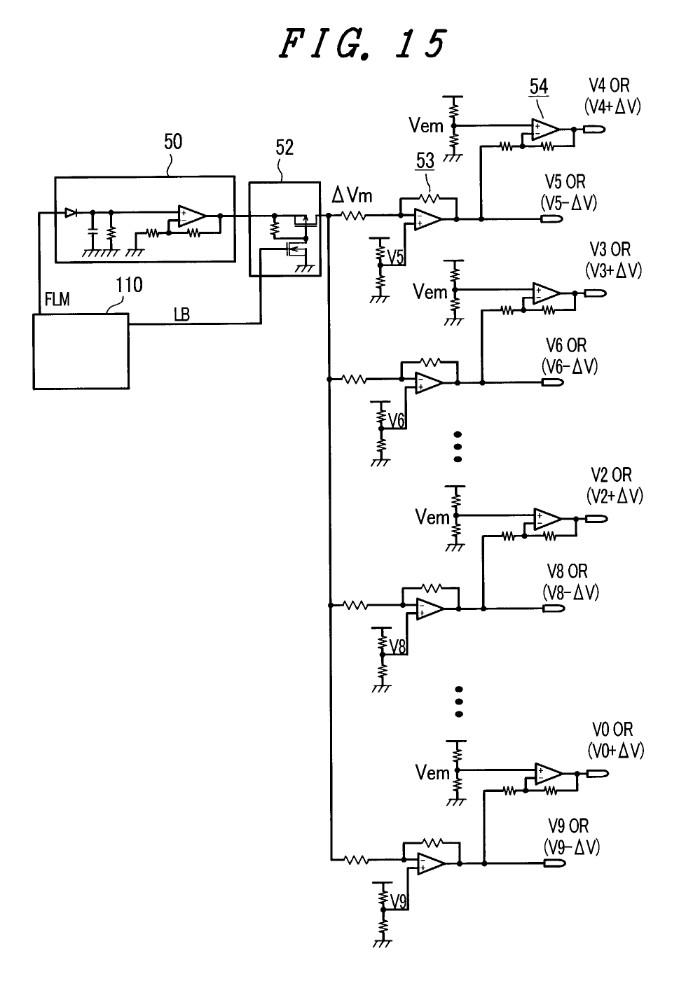

An input waveform upon inputting of the correction voltages (ΔVm) shown in FIGS. 12B to 12C to the inverting amplifier circuit 1 (53) through the switch circuit 52 is shown in FIG. 13.

Note here that in cases where the influence due to a difference in distance from the drain drivers 130, the correction voltage (ΔVm) may be kept constant within one frame period as shown in FIG. 12A.

In this embodiment, the correction voltage (ΔVm) which is generated by the correction voltage generator unit 51 is generated as the one with a voltage waveform shown in FIG. 12B.

To this end, the illustrative embodiment is arranged to use a method having the steps of charging a capacitive element (Cm) by a pulsate frame start-up instruction signal (FLM) outputted in every frame, adjusting the capacitance value of the capacitive element (Cm) and the resistance value of a resistive element (Rm1), adjusting the discharge characteristics of electrical charge charged at the capacitive element (Cm), further adjusting the resistance values of resistive elements (Rm2, Rm3) of the correction voltage generator unit 51, and then adjusting the amplification degree of an op-amp (OP3) configuring the inverting amplifier circuit, thereby adjusting its voltage level.

Here, the capacitance value of the above-noted capacitive element (Cm) and the values of the resistive elements (Rm1, Rm2, Rm3) are adjusted in every gradation reference voltage in such a way that the correction voltage (ΔVm) is different with respect to each of the gradation reference voltages (V5 to V9).

As apparent from the foregoing, in accordance with this embodiment, an arbitrary correction voltage (ΔVm) is given for each gradation reference voltage, thus making it possible to correct each gradation voltage.

Examples of the voltage amount (ΔV) of a correction voltage which is given for each gradation reference voltage used to generate each positive gradation voltage are shown by curves (a), (b), (c) in a graph of FIG. 14. Note that this graph of FIG. 14 shows a case where the gradation reference voltages are from 1 to M.

[Embodiment 2]

<Characteristic Arrangement of Liquid Crystal Display Module of this Embodiment>

FIG. 15 is a circuit diagram showing a schematic configuration of a gradation reference voltage generator circuit 121 of a liquid crystal display module in accordance with the Embodiment 2 of this invention.

As shown in FIG. 15, this embodiment is the one that provides a single correction voltage generator unit 50 in place of the correction voltage generator unit 51 which generates a correction voltage (ΔVm) with respect to each of the gradation reference voltages (V5 to V9), wherein a correction voltage (ΔVm) that is generated by this correction voltage generator unit 50 is for use as the correction voltage of each of the gradation reference voltages (V5 to V9).

Note that an operation of the gradation reference voltage generator circuit 121 of this embodiment is the same as that of the above-stated Embodiment 1 so that a detailed explanation thereof is omitted herein.

[Embodiment 3]

<Characteristic Arrangement of Liquid Crystal Display Module of the Embodiment>

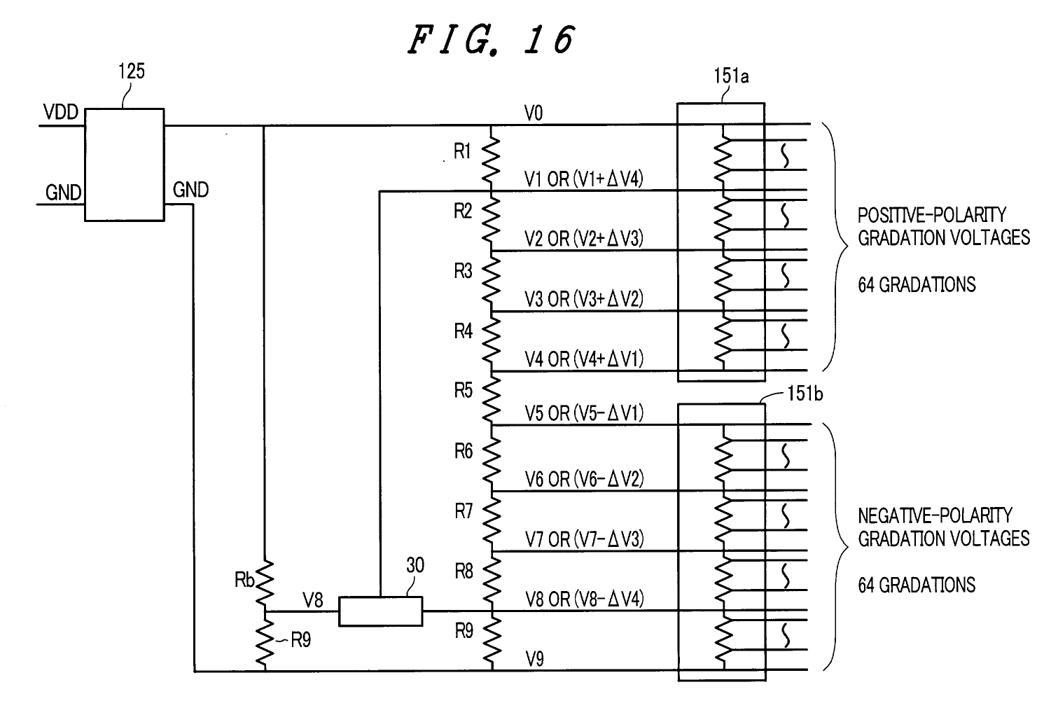

FIG. 16 is a circuit diagram showing a schematic configuration of a gradation reference voltage generator circuit 121 of a liquid crystal display module in accordance with Embodiment 3 of this invention.

Although the circuit configurations of the above-mentioned Embodiments 1, 2 are ideal, these require the use of a great number of circuit elements such as op-amps, resistive elements, capacitive elements and others, resulting in an increase in production cost and an increase in mount area. To avoid these risks, this embodiment is the one that gives the correction voltage (ΔVm) only to the gradation reference voltage of V1 and the gradation reference voltage of V8 as shown in FIG. 16.

As shown in FIG. 16, in this embodiment, a resistive voltage divider circuit consisting essentially of resistors Rb, R9 is provided to potentially divide a voltage between a voltage V0 outputted from DC/DC converter 125 and the ground potential (GND) to thereby generate a gradation reference voltage of V8, which is then input to a correction circuit 30.

Another resistive voltage divider circuit consisting of resistors R1 to R9 is provided to constitute a gradation reference voltage generation circuit, wherein this resistive voltage divider circuit is for potentially dividing a voltage between the voltage V0 as outputted from the DC/DC converter 125 and the ground potential (GND) to thereby generate gradation reference voltages of V0 to V9.

And, an output of the correction circuit 30 is connected to a voltage division point or node which outputs the gradation reference voltage of V1 and the gradation reference voltage of V8 of the resistive voltage divider circuit made up of the resistors R1 to R9.

The circuit configuration of this correction circuit 30 is the same as that of the correction circuit shown in FIG. 10.

Accordingly, when the line discrimination signal (LB) is at L level, the gradation reference voltages of V1 and V8 which are outputted from the correction circuit 30 become equal to the gradation reference voltages of V1 and V8 generated by the resistive voltage divider circuit made up of the resistors R1 to R9, causing a predetermined gradation reference voltage to be supplied to the drain driver(s) 130.

Alternatively, when the line discrimination signal (LB) is at H level, the corrector circuit 30 outputs a corrected gradation reference voltage of (V1+ΔVm) and a corrected gradation reference voltage of (V8−ΔVm).

Additionally, in view of the fact that the gradation reference voltages of V2 to V7 are generated by voltage division of a voltage between the voltage of (V1+ΔVm) and the voltage of (V8−ΔVm), the gradation reference voltages of V2 to V7 also become corrected gradation reference voltages.

It should be noted that in this embodiment, the voltage value of the correction voltage (ΔVm) becomes maximum at the time of the gradation reference voltages of V1 and V8, become smaller with an increase in difference from the gradation reference voltages of V1 and V8, and become minimum at the time of the gradation reference voltages of V4 and V5.

An example of the voltage amount (ΔV) of a correction voltage which is given with respect to each gradation reference voltage used to generate each positive gradation voltage at this time is shown by (d) in FIG. 14.

Although the gradation reference voltages of V0 and V9 are not corrected here, this causes no specific problems because lateral stripes are not visible to human eyes depending upon the gradation to be displayed by a nearby gradation voltage by way of example.

Also note that although in FIG. 16 the gradation reference voltages of V2 to V7 falling between the gradation reference voltages of V1 and V8 are generated by the resistive voltage divider circuit after completion of correction relative to the gradation reference voltages of V1 and V8, a combination of gradation reference voltages of V2 and V7 may be used in lieu of the gradation reference voltages of V1 and V8, and the gradation reference voltages of V2 and V7 are corrected.

Alternatively a combination of gradation reference voltages of V0 and V9 may be used and corrected. In this case, the correction voltages such as those indicated by (a), (b), (c) in FIG. 14 are obtained.

An explanation will next be given of a method for generating the AC-converted signal (M) and the line discrimination signal (LB) in each of the embodiments stated supra.

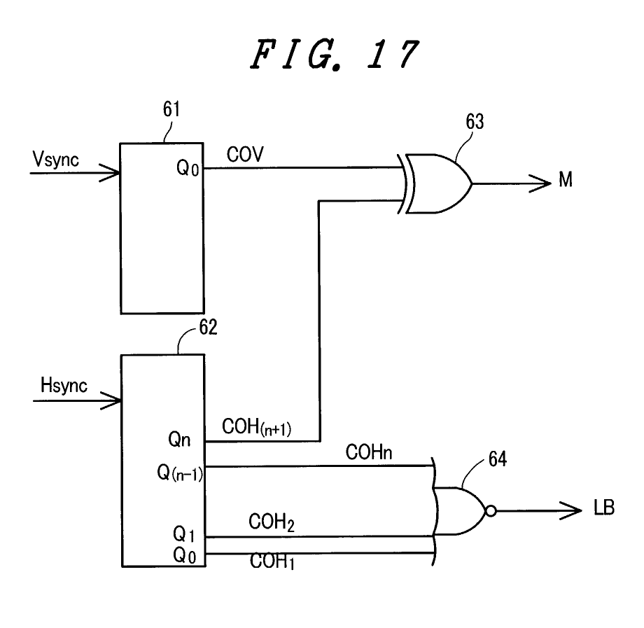

FIG. 17 is a circuit diagram showing a configuration of a circuit for generating the AC-converted signal (M) and line discriminant signal (LB) in each of the embodiments.

As shown in FIG. 17, a counter 61 is provided for counting pulses of a vertical sync signal (Vsync) and for inputting a Q₀ output of a counter 61 to an exclusive-OR (Ex-OR) gate circuit 63. Here, the Q₀ output of counter 61 potentially changes alternately between H and L levels at a time whenever the vertical sync signal (Vsync) is inputted.

Another counter 62 is provided to count pulses of a horizontal sync signal (Hsync) and output count signals Q₀ to Qₙ₋₁, which are then input to a NOR gate circuit 64. This NOR gate 64 generates its output signal for use as the line discriminant signal.

The counter 62 also generates an output signal Qₙ, which is inputted to the Ex-OR gate 63, which in turn issues an output signal for use as the AC-converted signal.

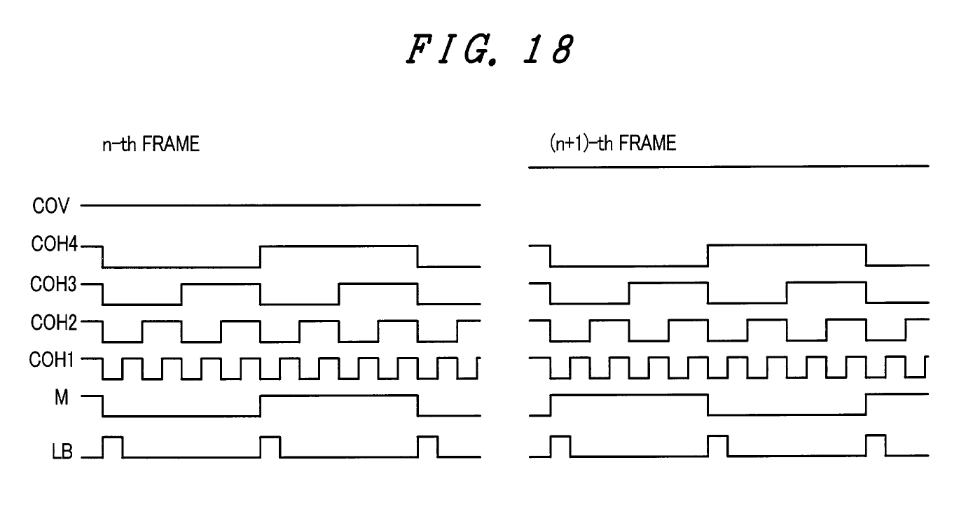

A timing chart of the circuit of FIG. 17 in the case of 8 (n=3) line inversion method is shown in FIG. 18.

In FIG. 18, “COV” designates the Q₀ output of the counter 61 whereas COH1 to COH4 denote the Q₀ to Qₙ outputs of the counter 62.

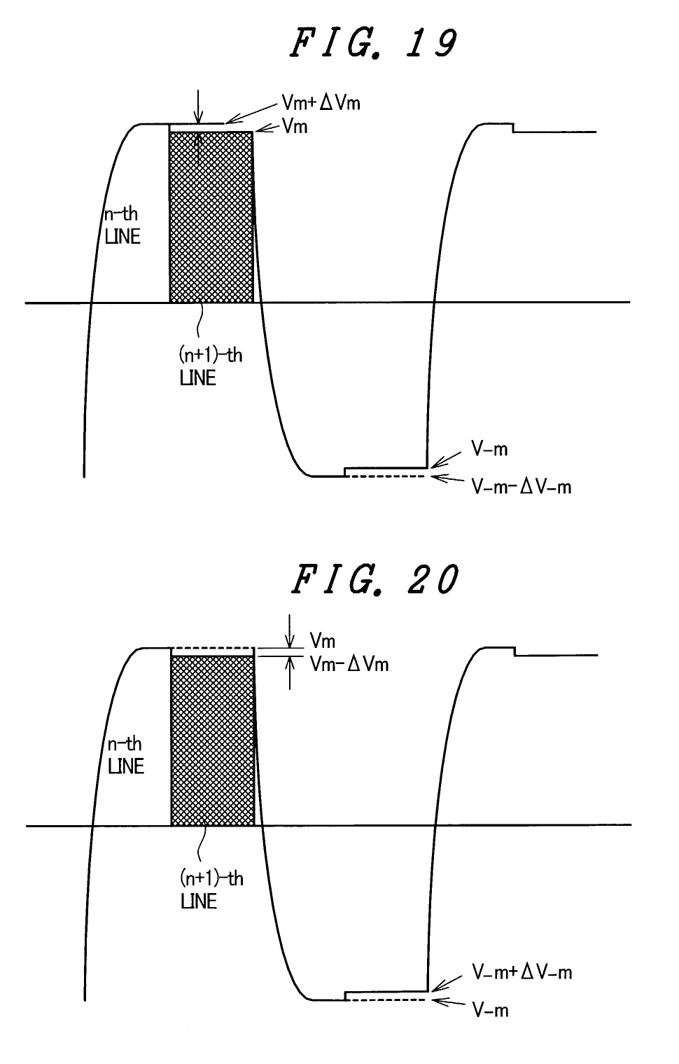

Although in each of the above-stated embodiments the gradation voltage to be outputted from a drain driver 130 to a pixel(s) on the n-th line is corrected in such a way that the voltage as written into the pixel on the n-th line immediately after polarity inversion and the voltage being written into a pixel(s) on the (n+1)th line subsequent to the n-th line immediately after the polarity inversion become equal to each other as shown in FIG. 19, the gradation voltage being outputted from the drain driver 130 to the pixel on the (n+1)th line may be corrected so that the voltage as written into the pixel on the n-th line immediately after the polarity inversion becomes equal to the voltage being written into the pixel on the (n+1)th line subsequent to the n-th line immediately after the polarity inversion as shown in FIG. 20.

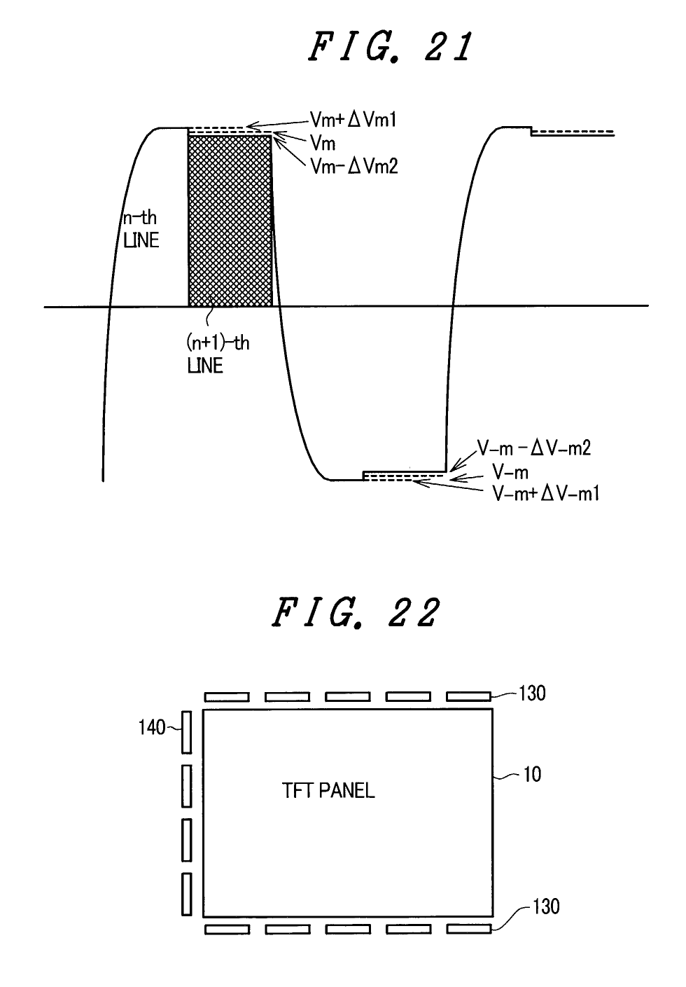

Alternatively, as shown in FIG. 21, the gradation voltages which are outputted from the drain driver 130 to the pixels of the n-th line and (n+1)th line may be corrected in such a way that the voltage as written into the pixel on the n-th line immediately after the polarity inversion becomes equal to the voltage being written into the pixel on the (n+1)th line subsequent to the n-th line immediately after the polarity inversion.

Note that in FIGS. 19 to 21, examples are provided of inverting and driving for every two lines in a group.

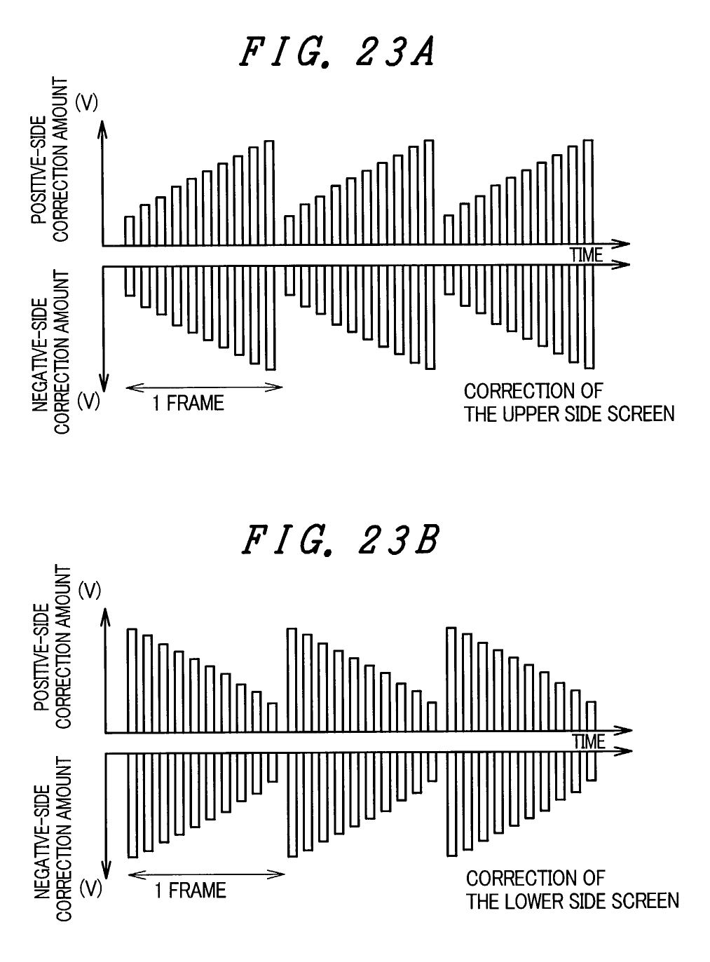

Also note that although in each of the above embodiments the explanation is made relative to the case where the drain drivers 130 are mounted along one of the long sides of the liquid crystal display panel 10: in case the drain drivers 130 are mounted along the both of the long sides of the liquid crystal display panel 10 as shown in FIG. 22 as an example, it should be required as shown in FIGS. 23 and 23B to prepare as the voltage waveform of a correction voltage (ΔVm) for use on a per-frame basis two types of waveforms, one of which is for use as a gradation voltage (waveform shown in FIG. 23A) to be outputted from drain drivers 130 on the upper side of the liquid crystal display panel 10 and the other of which is for use as a gradation voltage (waveform shown in FIG. 23B) being outputted from the other drain drivers 130 on the lower side of liquid crystal display panel 10.

In this way, according to each of the embodiments described above, in case a multiple-line inversion method is employed as the driving method thereof, it becomes possible to prevent occurrence of lateral stripes on the display screen of the liquid crystal display panel 10, thereby making it possible to improve the display quality of the display screen to be displayed on the liquid crystal display panel 10.

[Embodiment 4]

<Characteristic Arrangement of Liquid Crystal Display Module of the Embodiment>

In each of the embodiments, the gradation voltage to be outputted from a drain driver 130 to a pixel on the n-th line is corrected to cause the voltage written into the pixel on the n-th line immediately after the polarity inversion and the voltage being written into the pixel on the (n+1)th line subsequent to the n-th line immediately after the polarity inversion to become equal to each other.

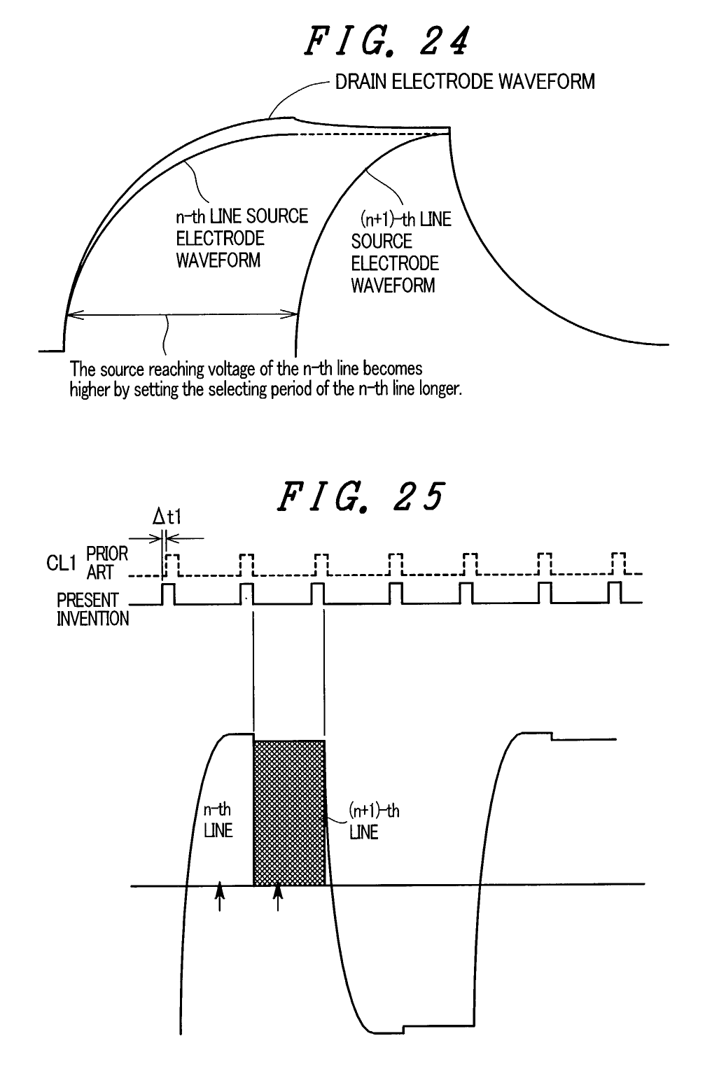

This embodiment is the one that is arranged as shown in FIG. 24 to let the length of a horizontal scan period (i.e. scan time or select time) of the n-th line immediately after the polarity inversion be greater than the length of a horizontal scan period of the (n+1)th line subsequent to the n-th line immediately after the polarity inversion, in addition to the drive method of each of the embodiments above.

Generally, even at gate signal lines (G) also, waveform rounding corruption occurs in select signals outputted from gate drivers 140 in a similar way to drain signal lines (D), resulting in a decrease in length of the turn-on period of thin-film transistors (TFT1, TFT2) at locations far from the gate drivers 140. That is, the greater the distance from the gate drivers 140, the shorter the TFT turn-on period.

Whereby, lateral stripes occurring on the display screen of the liquid crystal display panel 10 also become visible to human eyes more appreciably at pixels farther from the gate drivers 140.

For prevention of such on-screen lateral stripes, it is effective to lengthen the scan time of the n-th line immediately after the polarity inversion so that it is longer than the scan time of the (n+1)th line subsequent to the n-th line immediately after the polarity inversion.

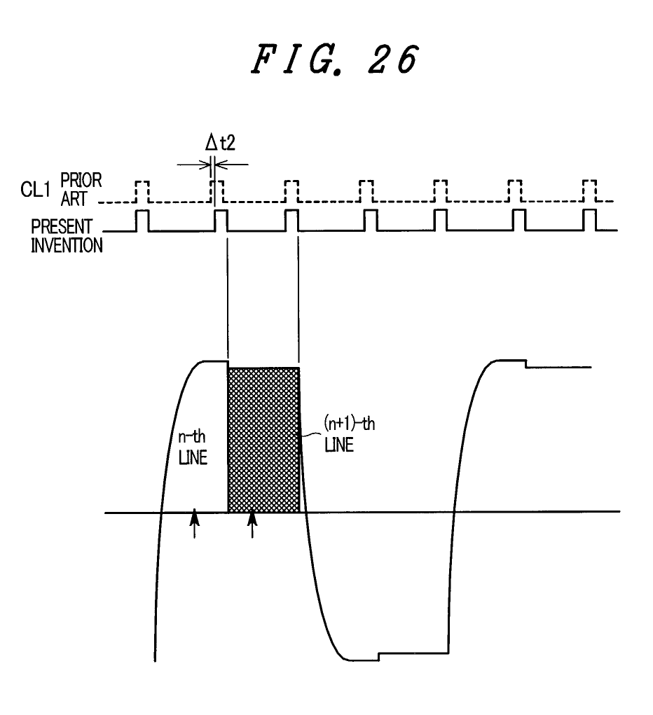

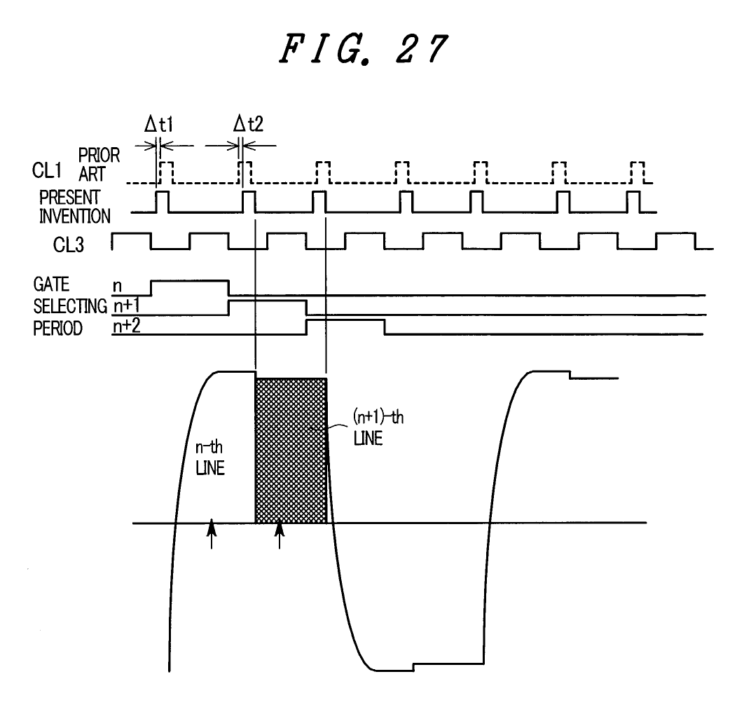

In this embodiment, methodology for lengthening one horizontal scan period of the above-stated n-th line immediately after the polarity inversion includes, but not limited to, a method for making the generation a timing of the clock (CL1) at the n-th line immediately after the polarity inversion earlier than the prior art as shown in FIG. 25, a method for making the generation timing of the clock (CL1) at the (n+1)th line subsequent to the n-th line immediately after the polarity inversion later than the prior art as shown in FIG. 26, or a method for making the generation timing of the clock (CL1) at the n-th line immediately after the polarity inversion earlier than the prior art while at the same time making the generation timing of the clock (CL1) at the (n+1)th line subsequent to the n-th line immediately after the polarity inversion later than the prior art as shown in FIG. 27.

Note that arrows are shown in FIGS. 25 to 27 to indicate the timings of the outputs from the drain drivers 130.

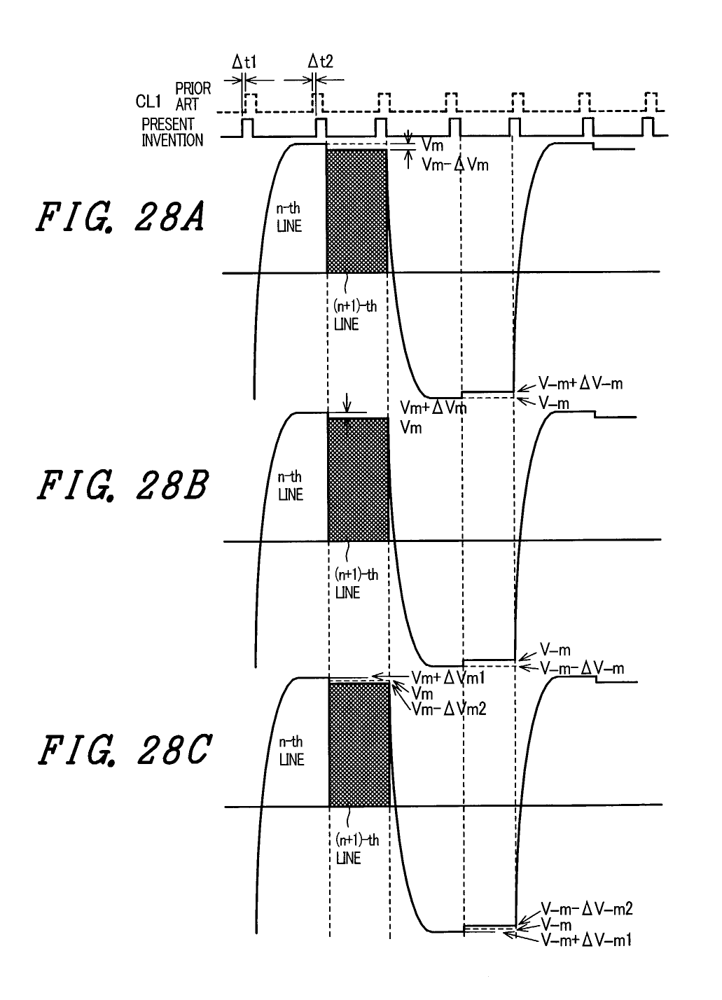

There are shown in FIGS. 28A to 28C the case of combining together the method for making the generation timing of the clock (CL1) at the n-th line immediately after the polarity conversion earlier than the prior art while simultaneously making the generation timing of the clock (CL1) at the (n+1)th line subsequent to the n-th line immediately after the polarity inversion later than the prior art in order to equalize the voltage to be written into the pixel on the n-th line immediately after the polarity inversion and the voltage being written into the pixel on the (n+1)th line subsequent to the n-th line immediately after the polarity inversion and the above-stated method shown in FIG. 19 for correcting the gradation voltage to be outputted from the drain driver 130 to the pixel on the n-th line (FIG. 28B), and the case for combination with the method shown in FIG. 20 for correcting the gradation voltage being outputted from the drain driver 130 to the pixel on the (n+1)th line (FIG. 28A), and also the case for combination with the method shown in FIG. 21 for correcting the gradation voltage outputted from a drain driver 130 to the pixels on the n-th line and (n+1)th line (FIG. 28C).

An explanation will be given of a method for adjusting the generation timing of the clock (CL1) in this embodiment.

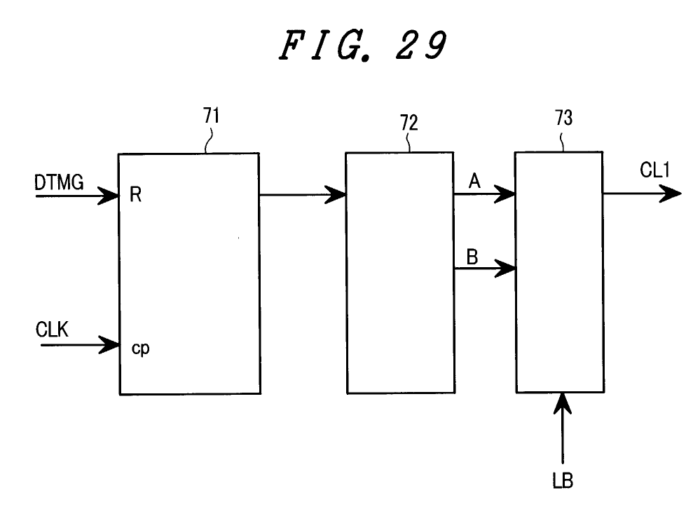

FIG. 29 is a circuit diagram showing a configuration of circuitry which adjusts the generation timing of the clock (CL1).

In FIG. 29, a counter 71 is reset by a display timing signal (DTMG) and counts the clock number of clocks (CLK) from a time point at which the display timing signal (DTMG) becomes at H level.

While the count number of this counter 71 is inputted to a decoder 72, the decoder 72 outputs a pulse signal at its output terminal “A” when the count number is a first counter number and outputs a pulse signal at an output terminal “B” when the count number is a second counter number.

The pulse outputted from the output terminal A of the decoder 72 or from the output terminal B thereof is selected by a multiplexer 73 which is controlled by a correction line discrimination signal (LB), thus becoming the clock (CL1).

In this way, with this embodiment, in addition to the method of each of the embodiments stated previously, the length of the horizontal scan period of the n-th line immediately after the polarity inversion is made longer than the length of the horizontal scan period of the (n+1)th line subsequent to the n-th line immediately after the polarity inversion; thus, in the case of employing a multiple-line inversion method as the drive method, it becomes possible to preclude occurrence of lateral stripes on the entire area of the display screen of liquid crystal display panel 10, thus enabling further improvement in display quality of the display screen to be displayed on the liquid crystal display panel 10.

It must be noted that a method for making the horizontal scan period of a line immediately after polarity inversion longer than the horizontal scan period of its subsequent line, which method is for use as the drive method in a liquid crystal display device employing the N-line inversion method, is disclosed in JP-A-9-15560.

However, the method for lengthening the horizontal scan period of a line immediately after polarity inversion so that it is longer than the horizontal scan period of its subsequent line is deficient in effect of preventing lateral stripes occurring on the liquid crystal display panel 10 stated supra.

Additionally, although the above-identified Japanese document discloses therein that the horizontal scan period of the line immediately after the polarity inversion is lengthened to 1.1 to 1.4 times longer than the horizontal scan period of its subsequent line, it is no longer possible in cases where the horizontal scan period is short to make the horizontal scan period of the line immediately after polarity inversion significantly longer than the horizontal scan period of its subsequent line.

In view of the fact that the lateral stripes occurring on the liquid crystal display panel 10 are viewable more appreciably for lines far from the drain drivers 130 as stated previously, the method as taught by the above Japanese document is incapable of preventing both the lateral stripes occurring at lines near the drain drivers 130 and the lateral stripes occurring at lines far from the drain drivers 130 at a time. The Japanese document fails to teach nor suggest in any way the technique for preventing both the lateral stripes occurring at lines near the drain drivers 130 and the lateral stripes occurring at lines far from drain drivers 130.

It should be noted that although in the above explanation specific embodiments which apply the present invention to liquid crystal display panels of the type employing longitudinal electric field schemes have been described, this invention should not be limited only to these embodiments and may alternatively be applied to liquid crystal display panels of the type using lateral electric field schemes.

In the longitudinal electric field scheme liquid crystal display panel shown in FIG. 2 or 3, the common electrode (ITO2) is provided on or above a substrate opposing the TFT substrate. In contrast, with the lateral electric field scheme liquid crystal display panels, an opposite or “counter” electrode (CT) and its associative counter electrode signal line (CL) for applying a common voltage (Vcom) to the counter electrode (CT) are provided on the TFT substrate.

Due to this, a liquid crystal capacitance (Cpix) is equivalently connected between a pixel electrode (PX) and the counter electrode (CT). Additionally a storage capacitor (Cstg) is formed between the pixel electrode (PX) and counter electrode (CT).

Also note that in the individual embodiment stated above an embodiment employing the multiple-line inversion method as a driving method has been explained. The present invention should not exclusively be limited thereto and may alternatively be applicable to ones using the common inversion method for inverting the drive voltages which are applied to the pixel electrode (ITO1) and common electrode (ITO2) on a per-multiline basis.

Although the present invention made by the inventors as named herein has been explained in detail based on the embodiments thereof, it is appreciated that this invention should not be limited only to such embodiments and may be modified without departing from the spirit and scope of the invention.

A brief explanation of the effect obtainable by a representative one of the inventive concepts as disclosed herein is as follows.

In accordance with the invention, in the case of driving while inverting the polarity of a gradation voltage for every line N (N≧2), it becomes possible to prevent unwanted creation of on-screen lateral stripes, thus enabling improvement in display quality of a display screen to be displayed on a liquid crystal display element.

What is claimed is:

1. A method for driving a liquid crystal display device having a plurality of pixels and a driver circuit for outputting to each pixel a gradation voltage as selected from among M (M≧2) gradation voltages, characterized in that
the gradation voltage being outputted from the driver circuit to each pixel is inverted in polarity for every N (N≧2)-line group and that a voltage value of an m (1≦m≦M)-th gradation voltage to be outputted from the driver circuit to each pixel is made different between when being outputted to a pixel on a first line immediately after polarity inversion and when being outputted to a pixel on a polarity-noninverted line subsequent to the first line immediately after the polarity inversion.

2. A method for driving a liquid crystal display device according to claim 1, characterized in that an absolute value of a difference between the m-th gradation voltage being outputted from the driver circuit to each pixel and a common voltage is greater when being outputted from the driver circuit to the pixel on the first line immediately after polarity inversion than when being outputted from the driver circuit to the pixel on the polarity-noninverted line.

3. A method for driving a liquid crystal display device according to claim 1, characterized in that an absolute value of a difference between the gradation voltage being outputted from the driver circuit to the pixel on the first line immediately after polarity inversion and the gradation voltage to be outputted from the driver circuit to the pixel on the polarity-noninverted line is different on a per-gradation basis.

4. A method for driving a liquid crystal display device according to claim 3, characterized in that when the absolute value of a difference between the gradation voltage and the common voltage is greater, the absolute value of a difference between the gradation voltage being outputted from the driver circuit to the pixel on the first line immediately after the polarity inversion and the gradation voltage to be outputted from the driver circuit to the pixel on the polarity-noninverted line is greater.

5. A method for driving a liquid crystal display device according to claim 1, characterized in that when a distance between a line being scanned and the driver circuit is greater, the absolute value of a difference between the m-th gradation voltage being outputted from the driver circuit to the pixel on the first line immediately after the polarity inversion and the m-th gradation voltage to be outputted from the driver circuit to the pixel on the polarity-noninverted line is greater.

6. A method for driving a liquid crystal display device having a plurality of pixels, a drive circuit for outputting a gradation voltage to each pixel, and a power supply circuit for supplying K (K≧2) gradation reference voltages to the drive circuit, characterized in that
a gradation voltage being outputted from the drive circuit to each pixel is inverted in polarity for every N (N≧2)-line group, and that a voltage value of a k (1≦k≦K)-th gradation reference voltage being supplied from the power supply circuit to the drive circuit is made different between when outputting a gradation voltage from the drive circuit to the pixel on a first line immediately after polarity inversion and when outputting a gradation voltage from the drive circuit to the pixel on a polarity-noninverted line subsequent to the first line immediately after the polarity inversion.

7. A method for driving a liquid crystal display device according to claim 6, characterized in that a voltage value of a gradation reference voltage from 1 up to (K−1)th one is made different between when outputting a gradation voltage from the drive circuit to the pixel on the first line immediately after the polarity inversion and when outputting a gradation voltage from the drive circuit to the pixel on the polarity-noninverted line.

8. A method for driving a liquid crystal display device according to claim 6, characterized in that an absolute value of a difference between the k-th gradation reference voltage being supplied from the power supply circuit to the drive circuit and a common voltage is greater when outputting a gradation voltage from the drive circuit to the pixel on the first line immediately after the polarity inversion than when outputting from the drive circuit to the pixel on the polarity-noninverted line.

9. A method for driving a liquid crystal display device according to claim 6, characterized in that an absolute value of a difference between the gradation reference voltage supplied from the power supply circuit to the drive circuit when outputting a gradation voltage from the drive circuit to the pixel on the first line immediately after the polarity inversion and the gradation reference voltage supplied from the power supply circuit to the drive circuit when outputting from the drive circuit to the pixel on the polarity-noninverted line is different with respect to each gradation reference voltage.

10. A method for driving a liquid crystal display device according to claim 9, characterized in that when the absolute value of a difference between the gradation reference voltage and the common voltage is greater, the absolute value of a difference between the gradation reference voltage to be supplied from the power supply circuit to the drive circuit when outputting a gradation voltage from the drive circuit to the pixel on the first line immediately after the polarity inversion and the gradation reference voltage to be supplied from the power supply circuit to the drive circuit when outputting a gradation voltage from the drive circuit to the pixel on the polarity-noninverted line is greater.

11. A method for driving a liquid crystal display device according to claim 6, characterized in that the absolute value of a difference between the k-th gradation reference voltage being supplied from the power supply circuit to the drive circuit when outputting a gradation voltage from the drive circuit to the pixel on the first line immediately after the polarity inversion and the k-th gradation reference voltage supplied from the power supply circuit to the drive circuit when outputting a gradation voltage from the drive circuit to the pixel on the polarity-noninverted line is greater with an increase in a distance between a line to be scanned and the drive circuit.

12. A method for driving a liquid crystal display device according to claim 1, characterized in that a horizontal scan time period of the line is different between when outputting a gradation voltage from the drive circuit to the pixel on the first line immediately after the polarity inversion and when outputting a gradation voltage from the drive circuit to the pixel on the polarity-noninverted line.

13. A method for driving a liquid crystal display device according to claim 1, characterized in that the polarity of the gradation voltage to be outputted from the drive circuit to each pixel is inverted for every two-line group.

14. A liquid crystal display device having a plurality of pixels and a drive circuit for outputting to each pixel a gradation voltage as selected from among M (M≧2) gradation voltages and also for inverting a polarity of a gradation voltage to be outputted to each pixel for every N (N≧2)-line group, characterized by having
a correction circuit for letting a voltage value of an m (1≦m≦M)-th gradation voltage to be outputted from the drive circuit to each pixel be different between when outputting to a pixel on a first line immediately after polarity inversion and when outputting to a pixel on a polarity-noninverted line subsequent to the first line immediately after the polarity inversion.

15. A liquid crystal display device according to claim 14, characterized in that the correction circuit corrects the voltage value of the gradation voltage in such a way that an absolute value of a difference between the m-th gradation voltage to be outputted from the drive circuit to each pixel and a common voltage becomes greater when outputting a gradation voltage from the drive circuit to the pixel on the first line immediately after the polarity inversion than when outputting a gradation voltage from the drive circuit to the pixel on the polarity-noninverted line.

16. A liquid crystal display device according to claim 14, characterized in that the correction circuit corrects the voltage value of the gradation voltage in such a way that an absolute value of a difference between a gradation voltage to be outputted from the drive circuit to the pixel on the first line immediately after the polarity inversion and a gradation voltage to be outputted from the drive circuit to the pixel on the polarity-noninverted line is different with respect to each gradation.

17. A liquid crystal display device according to claim 16, characterized in that the correction circuit corrects the voltage value of the gradation voltage in such a way that the absolute value of a difference between the gradation voltage to be outputted from the drive circuit to the pixel on the first line immediately after the polarity inversion and the gradation voltage to be outputted from the drive circuit to the pixel on the polarity-noninverted line becomes greater with an increase in absolute value of a difference between the gradation voltage and the common voltage.

18. A liquid crystal display device according to claim 14, characterized in that the correction circuit corrects the voltage value of the gradation voltage in such a way that the absolute value of a difference between the m-th gradation voltage being outputted from the drive circuit to the pixel on the first line immediately after the polarity inversion and the m-th gradation voltage to be outputted from the drive circuit to the pixel on the polarity-noninverted line becomes greater with an increase in distance between a line to be scanned and the drive circuit.

19. A liquid crystal display device having a plurality of pixels, a drive circuit for outputting a gradation voltage to each pixel and for inverting a polarity of the gradation voltage being outputted to each pixel for every N (N≧2)-line group, and a power supply circuit for supplying K (K≧2) gradation reference voltages to the drive circuit, characterized by having
a correction circuit for causing a voltage value of a k (1≦k≦K)-th gradation reference voltage supplied from the power supply circuit to the drive circuit to be different between when outputting a gradation voltage from the power supply circuit to a pixel on a first line immediately after polarity inversion and when outputting a gradation voltage from the drive circuit to a pixel on a polarity-noninverted line subsequent to the first line immediately after the polarity inversion.

20. A liquid crystal display device according to claim 19, characterized in that
the power supply circuit has a voltage divider circuit for potentially dividing a voltage between a first power supply voltage and a second power supply voltage and for generating the K gradation reference voltages, and that
the correction circuit has a correction voltage generator circuit for generating a correction voltage and a voltage adder circuit for adding, upon output of a gradation voltage from the drive circuit to the pixel on the first line immediately after the polarity inversion, the correction voltage generated at the correction voltage generator circuit to a k (1≦k≦K)-th gradation reference voltage to be generated by the voltage divider circuit.

21. A liquid crystal display device according to claim 20, characterized in that the correction voltage generator circuit generates the correction voltage in such a manner that an absolute value of a difference between the k-th gradation reference voltage supplied from the power supply circuit to the drive circuit and a common voltage becomes greater when outputting a gradation voltage from the drive circuit to the pixel on the first line immediately after the polarity inversion than when outputting a gradation voltage from the drive circuit to the pixel on the polarity-noninverted line.

22. A liquid crystal display device according to claim 19, characterized in that
the power supply circuit has a voltage divider circuit for generating the K gradation reference voltages by potentially dividing a voltage between a first power supply voltage and a second power supply voltage, and that
the correction circuit has a correction voltage generator circuit for generating a correction voltage and a voltage adder circuit for adding, when letting a gradation reference voltage with a maximum absolute value of a difference between the gradation reference voltage and the common voltage as the K-th gradation reference voltage, the correction voltage being generated at the correction voltage generator circuit to first and (K−1)th gradation reference voltages to be generated by the voltage divider circuit upon output of a gradation voltage from the drive circuit to the pixel on the first line immediately after the polarity inversion.

23. A liquid crystal display device according to claim 22, characterized in that the correction voltage generator circuit generates the correction voltage in such a manner that the absolute value of a difference between the first and (K−1)th gradation reference voltages being supplied from the power supply circuit to the drive circuit and the common voltage becomes greater when outputting a gradation voltage from the drive circuit to the pixel on the first line immediately after the polarity inversion than when outputting a gradation voltage from the drive circuit to the pixel on the polarity-noninverted line.

24. A liquid crystal display device according to claim 20, characterized in that the voltage adder circuit has a switch circuit for turning on when outputting a gradation voltage from the drive circuit to the pixel on the first line immediately after the polarity inversion, and an amplifier circuit for receiving the correction voltage supplied thereto through the switch circuit and for adding the correction voltage to the gradation reference voltage.

25. A liquid crystal display device according to claim 20, characterized in that the correction voltage generator circuit has a capacitive element charged by a signal for instructing a time point for start up of line scanning and a resistive element for determination of a discharge time constant of the capacitive element.

26. A liquid crystal display device according to claim 25, characterized in that a capacitance value of the capacitive element and a resistance value of the resistive element are different per each gradation reference voltage.

27. A liquid crystal display device according to claim 26, characterized in that the capacitance value of the capacitive element and the resistance value of the resistive element are set at values in such a manner that the absolute value of a difference between a gradation reference voltage supplied from the power supply circuit to the drive circuit when outputting a gradation voltage from the drive circuit to the pixel on the first line immediately after the polarity inversion and a gradation reference voltage supplied from the power supply circuit to the drive circuit when outputting from the drive circuit to the pixel on the polarity-noninverted line becomes greater with an increase in absolute value of a difference between the gradation reference voltage and the common voltage.

28. A liquid crystal display device according to claim 14, characterized by having a circuit for causing the line to differ in horizontal scan time period between when outputting a gradation voltage from the drive circuit to the pixel on the first line immediately after the polarity inversion and when outputting a gradation voltage from the drive circuit to the pixel on the polarity-noninverted line.

29. A liquid crystal display device according to claim 14, characterized in that the drive circuit inverts the polarity of a gradation voltage to be outputted to each pixel for every two-line group.

30. A liquid crystal display device according to claim 19, characterized by having a circuit for causing the line to differ in horizontal scan time period between when outputting a gradation voltage from the drive circuit to the pixel on the first line immediately after the polarity inversion and when outputting a gradation voltage from the drive circuit to the pixel on the polarity-noninverted line.

31. A liquid crystal display device according to claim 19, characterized in that the drive circuit inverts the polarity of a gradation voltage to be outputted to each pixel for every two-line group.

32. A method for driving a liquid crystal display device according to claim 6, characterized in that a horizontal scan time period of the line is different between when outputting a gradation voltage from the drive circuit to the pixel on the first line immediately after the polarity inversion and when outputting a gradation voltage from the drive circuit to the pixel on the polarity-noninverted line.

33. A method for driving a liquid crystal display device according to claim 6, characterized in that the polarity of the gradation voltage to be outputted from the drive circuit to each pixel is inverted for every two-line group.
